(19) United States
(12) Patent Application Publication
(10) Pub. No.: US 2025/0358792 A1
(43) Pub. Date: Nov. 20, 2025

(54) METHOD AND APPARATUS FOR RESOURCE ACQUISITION AND OPERATION OF INTERMEDIATE NODE IN A WIRELESS COMMUNICATION SYSTEM

(71) Applicant: ASUS Technology Licensing Inc., Taipei City (TW)

(72) Inventors: Wei-Han Lai, Taipei City (TW); Yi-Hsuan Huang, Taipei City (TW); Meng-Hui Ou, Taipei City (TW); Yu-Hsuan Guo, Taipei City (TW); Ming-Che Li, Taipei City (TW)

(21) Appl. No.: 19/206,918

(22) Filed: May 13, 2025

Related U.S. Application Data
(60) Provisional application No. 63/648,038, filed on May 15, 2024.
(60) Provisional application No. 63/648,068, filed on May 15, 2024.

(51) Int. Cl. H04W 72/02; H04W 72/0446; H04W 72/0453; H04W 72/231; H04W 72/51

(52) U.S. Cl. CPC H04W 72/02; H04W 72/0446; H04W 72/0453; H04W 72/231; H04W 72/51

(57) ABSTRACT

Methods, systems, and apparatuses are provided for resource acquisition and operation of intermediate nodes in a wireless communication system, wherein a method for a User Equipment (UE) capable of acting or operating as an ambient Internet-of-Things (IoT) intermediate node in a wireless communication system comprises transmitting or providing one or more information in a first signaling, used to request resources for an (ambient IoT) intermediate node-related operation or an ambient IoT-related operation or procedure, to a network node, receiving one or more downlink signalings from the network node, determining a set of resources based on the one or more downlink signalings, and performing the (ambient IoT) intermediate node-related operation or the ambient IoT-related operation or procedure, via the set of resources, with one or more ambient IoT devices.

### CROSS-REFERENCE TO RELATED APPLICATIONS

The present Application claims priority to and the benefit of U.S. Provisional Patent Application Ser. No. 63/648,038, filed May 15, 2024, and U.S. Provisional Patent Application Ser. No. 63/648,068, filed May 15, 2024; with each of the referenced and listed applications and disclosures fully incorporated herein by reference.

### FIELD

This disclosure generally relates to wireless communication networks and, more particularly, to a method and apparatus for resource acquisition and operation of intermediate nodes in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for resource acquisition and operation of intermediate nodes in a wireless communication system. The intermediate node can acquire and utilize proper resources for ambient Internet-of-Things (IoT)-related operations. Further, an ambient IoT device could perform reception of Reader to (Ambient IoT) Device (R2D) transmission(s) from the intermediate node, and perform (Ambient IoT) Device to Reader (D2R) transmission(s) to the intermediate node, respectively.

In various embodiments, a method for a User Equipment (UE) capable of acting or operating as an ambient IoT intermediate node in a wireless communication system comprises transmitting or providing one or more information in a first signaling, used to request resources for an (ambient IoT) intermediate node-related operation or an ambient IoT-related operation or procedure, to a network node, wherein the one or more information comprises any of: information of an expected or estimated number of ambient IoT devices, information of (target) coverage for the (ambient IoT) intermediate node-related operation or the ambient IoT-related operation or procedure, information of (geographic) location of the UE, information of a type of the ambient IoT-related operation or procedure or service to be performed, information of a type of the ambient IoT devices to be served, accessed, or communicated, information of a number or an amount of requested resources, or information of a latency or how long to utilize the requested resources, receiving one or more downlink signalings from the network node, determining a set of resources based on the one or more downlink signalings, and performing the (ambient IoT) intermediate node-related operation or the ambient IoT-related operation or procedure, via the set of resources, with one or more ambient IoT devices.

In various embodiments, a method for a UE capable of acting or operating as an ambient IoT intermediate node in a wireless communication system comprises receiving one or more downlink signalings from a network node, determining a set of resources based on the one or more downlink signalings, performing an (ambient IoT) intermediate node-related operation or an ambient IoT-related operation or procedure, via the set of resources, with one or more ambient IoT devices, and transmitting or providing a signaling or indication to indicate at least one of: need of more resources if the UE needs to keep the set of resources or after or when the UE performs the (ambient IoT) intermediate node-related operation or the ambient IoT-related operation or procedure, or no need of (keeping/utilizing) resources if the UE does not need utilization of the set of resources or if the UE finishes the (ambient IoT) intermediate node-related operation or the ambient IoT-related operation or procedure.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 4.2.1.1-1: Topology 1, from 3GPP TR 38.848 V18.0.0 (2023 September).

FIG. 6 is a reproduction of FIG. 4.2.1.2-1: Topology 2, from 3GPP TR 38.848 V18.0.0 (2023 September).

FIG. 7 is a reproduction of a scenario table from RAN1 Chair's Notes for 3GPP TSG RAN WG1 #116bis.

FIG. 8 is an example diagram showing RFID design, inventory operation utilizing slot-based ALOHA, in accordance with embodiments of the present invention.

FIG. 9 is an example diagram showing that a cell is operated in FDD, wherein the cell may comprise a DL band and a UL band, in accordance with embodiments of the present invention.

FIG. 10 is an example diagram showing that a cell is operated in TDD, wherein the cell may comprise a TDD band, in accordance with embodiments of the present invention.

FIG. 11 is an example diagram showing that a UE (e.g., intermediate node) may transmit an assistance information to the NW, and the UE may receive a first DL signaling(s) which indicates the resource allocation for A-IoT, in accordance with embodiments of the present invention.

FIG. 12 is an example diagram showing that a second intermediate node (of a first device) may send a first information including a time information to a first intermediate node (of the first device), in accordance with embodiments of the present invention.

FIG. 13 is an example diagram showing that a first intermediate node (of a first device) may send a first information including a time information to a second intermediate node (of the first device), in accordance with embodiments of the present invention.

FIG. 14 is an example diagram showing that a first intermediate node (of a first device) may request for a set of resources (available) for the (first) device to perform a (subsequent) D2R transmission, in accordance with embodiments of the present invention.

FIG. 15 is an example diagram showing that a second intermediate node (of a first device) may request for a set of resources (available) for the device to perform the (subsequent) D2R transmission, in accordance with embodiments of the present invention.

FIG. 16 is an example diagram showing that a second intermediate node (of a first device) may provide a timing information to the network (e.g., with UE assistance information), in accordance with embodiments of the present invention.

FIG. 17 is an example diagram showing that a first intermediate node (of a first device) may provide a timing information to the network (e.g., with UE assistance information), in accordance with embodiments of the present invention.

FIG. 18 is an example diagram showing that a first intermediate node (of a first device) may request for a set of resources (available) for the (first) device to perform the (subsequent) D2R transmission, in accordance with embodiments of the present invention.

FIG. 19 is an example diagram showing that a second intermediate node (of a first device) may receive a signaling from a (first) device with a preference/expectance on one or more resources (available) for the (first) device to perform the (subsequent) D2R transmission, in accordance with embodiments of the present invention.

FIG. 20 is an example diagram showing that a first intermediate node (of a first device) may send a (first) request for a (first) set of resources (available) for the (first) device to perform the (subsequent) D2R transmission (e.g., before the first intermediate node performs D2R transmission), in accordance with embodiments of the present invention.

FIG. 21 is an example diagram showing instance/section 21(a) of aligning R2D transmission with UL timing, instance/section 21(b) of aligning the R2D transmission with the DL reception timing, and instance/section 21(c) of aligning the R2D transmission with the derived/determined DL transmission timing, in accordance with embodiments of the present invention.

FIG. 22 is an example diagram showing that in response to receiving the acknowledgment indication from the D2R intermediate node, the network node may send the acknowledgment indication to the R2D intermediate node, and the acknowledgment indication may be whether the first D2R transmission is successfully decoded or not, in accordance with embodiments of the present invention.

FIG. 23 is a flow diagram of a method of a network node in a wireless communication system comprising receiving a first information, for requesting resource(s), from a first UE, in response to receiving the first information, transmitting, to the first UE, a first D2R resource configuration for the first UE to indicate one or more D2R resources to a device, and transmitting, to a second UE, a second D2R resource configuration for the second UE to monitor/receive one or more D2R transmissions on the one or more D2R resources, in accordance with embodiments of the present invention.

FIG. 24 is a flow diagram of a method of a second UE in a wireless communication system comprising receiving a second D2R resource configuration, from a network node, and in response to receiving the second D2R resource configuration, receiving, from a device, one or more D2R transmissions on one or more D2R resources, in accordance with embodiments of the present invention.

FIG. 25 is a flow diagram of a method of a UE capable of acting or operating as an ambient IoT intermediate node in a wireless communication system comprises transmitting or providing one or more information in a first signaling, used to request resources for an (ambient IoT) intermediate node-related operation or an ambient IoT-related operation or procedure, to a network node, receiving one or more downlink signalings from the network node, determining a set of resources based on the one or more downlink signalings, and performing the (ambient IoT) intermediate node-related operation or the ambient IoT-related operation or procedure, via the set of resources, with one or more ambient IoT devices, in accordance with embodiments of the present invention.

FIG. 26 is a flow diagram of a method of a UE capable of acting or operating as an ambient IoT intermediate node in a wireless communication system comprises receiving one or more downlink signalings from a network node, determining a set of resources based on the one or more downlink signalings, performing an (ambient IoT) intermediate node-related operation or an ambient IoT-related operation or procedure, via the set of resources, with one or more ambient IoT devices, and transmitting or providing a signaling or indication to indicate at least one of: need of more resources if the UE needs to keep the set of resources or after or when the UE performs the (ambient IoT) intermediate node-related operation or the ambient IoT-related operation or procedure, or no need of (keeping/utilizing) resources if the UE does not need utilization of the set of resources or if the UE finishes the (ambient IoT) intermediate node-related operation or the ambient IoT-related operation or procedure, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WIMAX®, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] EPC® Radio-Frequency Identity Generation-2 UHF RFID Standard, Specification for RFID Air Interface Protocol for Communications at 860 MHz-930 MHz, Release 3.0, Ratified, January 2024; [2] RP-240826, “Revised SID: Study on solutions for Ambient IoT (Internet of Things) in NR”; [3] 3GPP TR 38.848 V18.0.0 (2023 September) 3GPP; TSG RAN; Study on Ambient IoT (Internet of Things) in RAN (Release 18); [4] R1-2401937, “Final Report of 3GPP TSG RAN WG1 #116 v1.0.0 (Athens, Greece, February 26-Mar. 1, 2024)”; [5] RAN1 Chair's Notes for 3GPP TSG RAN WG1 #116bis (Changsha, Hunan Province, China, April 15-19, 2024); [6] R1-2403749, “Feature lead summary #3 on downlink and uplink channel/signal aspects”, Moderator (Apple); [7] 3GPP TS 38.214 V18.2.0 (2024 March) 3GPP; TSG RAN; NR; Physical layer procedures for data (Release 18); and [8] 3GPP TS 38.212 V18.2.0 (2024 March) 3GPP; TSG RAN; NR; Multiplexing and channel coding (Release 18). The standards and documents listed above are hereby expressly and fully incorporated herein by reference in their entirety.

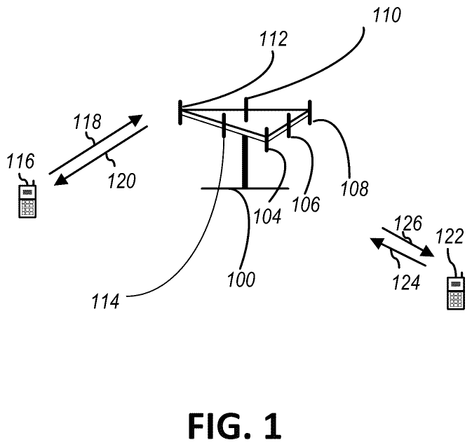

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

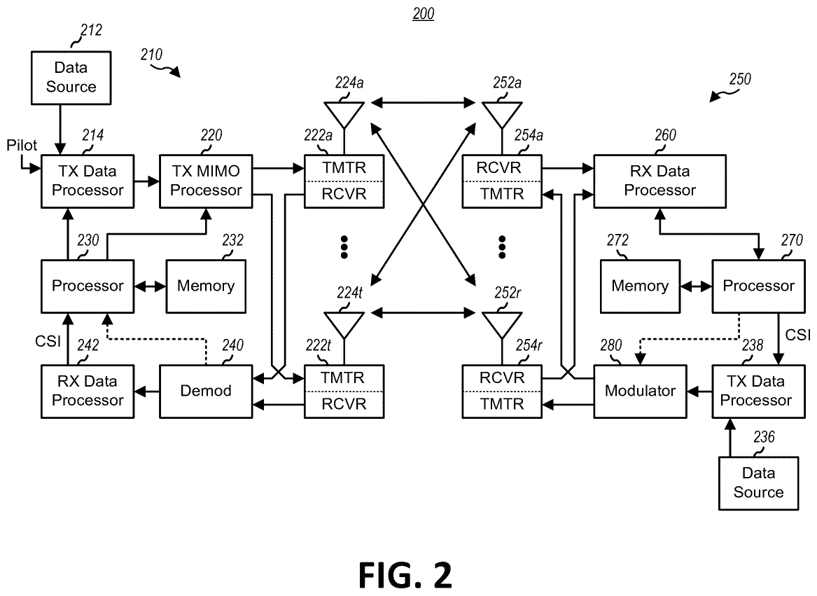

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides NT modulation symbol streams to Nr transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. Nr modulated signals from transmitters 222a through 222t are then transmitted from Nr antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from N_{R} receivers 254 based on a particular receiver processing technique to provide N_{T}“detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion. The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

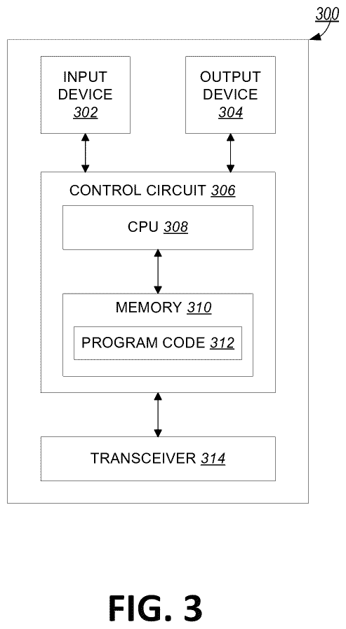

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

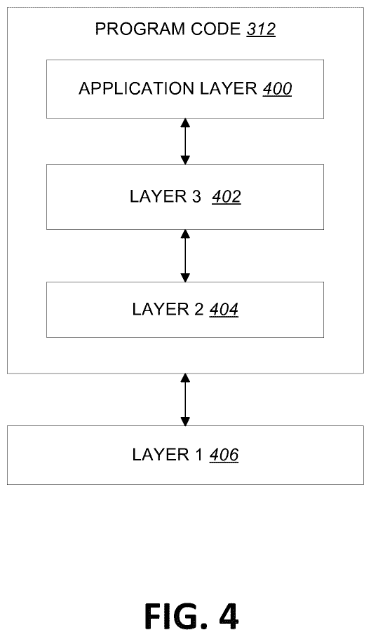

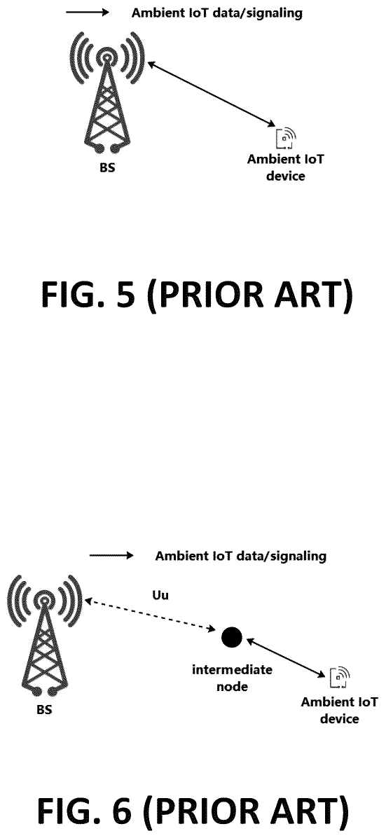

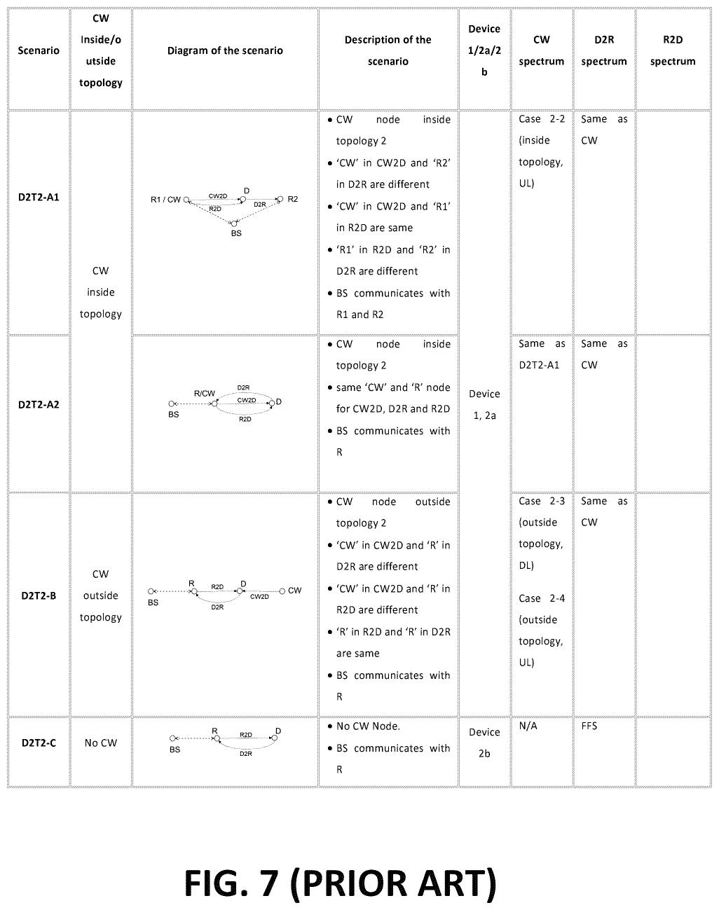

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus. The study item of ambient Internet of Things (IoT) is specified in [2] RP-240826, as provided below:

An ambient Internet-of-Things (IoT) device/User Equipment (UE) would have ultra-low complexity, very small device size and long life cycle. The ambient IoT device/UE would have complexity and power consumption orders of magnitude lower than the existing 3rd Generation Partnership Project (3GPP) Low-Power Wide-Area (LPWA) technologies (e.g., Narrowband (NB)-IoT, enhanced Machine Type Communication (eMTC)). The ambient IoT device/UE may not have energy storage or may have energy storage. The energy of ambient IoT device/UE may be provided through the harvesting of radio waves, light, motion, heat, or any other power source that could be suitable. The energy and/or power source may be provided one-shot (e.g., unexpected or aperiodically), periodically, or continuously. In one embodiment, the power/energy of Ambient IoT device/UE may be provided from a carrier wave from the network and/or an intermediate node. In Topology 1, the Ambient IoT device/UE would directly and bidirectionally communicate with a base station. In Topology 2, the Ambient IoT device/UE would communicate bidirectionally with an intermediate node (e.g., a UE or a relay node) between the Ambient IoT device/UE and the base station. The Uplink (UL) transmission of ambient IoT device/UE may be generated internally by the device/UE, or be backscattered on the carrier wave provided externally. More details regarding ambient IoT (devices/UEs) could be found in the study item [2] RP-240826 and [7] 3GPP TS 38.214 V18.2.0.

According to the study item of ambient IoT ([2] RP-240826), an ambient IoT UE has limited energy storage (may possibly even with no energy storage). Comparing New Radio (NR) UE with power consumption of mW (e.g., maximum UE transmit power 23 dBm corresponds to 199.5 mW), output power of an ambient IoT UE may be typically from 1 μW to a few hundreds of μW. Currently, the general scope is to address the following types of ambient IoT UEs:
A first type of ambient IoT UE may have 1 μW peak power consumption, with energy storage, with neither Downlink (DL) nor UL amplification. Transmission from the first type of ambient IoT UE may be backscattered on a carrier wave provided externally. The first type of ambient IoT UE may be a type of device 1, e.g., as described in [4] R1-2401937.
A second type of ambient IoT UE may have ≤a few hundred μW peak power consumption, with energy storage, with DL and/or UL amplification. Transmission from the second type of ambient IoT UE may be backscattered on a carrier wave provided externally (e.g., a type of Device 2a) or generated internally by the UE (e.g., a type of Device 2b). The second type of ambient IoT UE may be a type of Device 2a and/or Device 2b, e.g., as described in [4] R1-2401937.

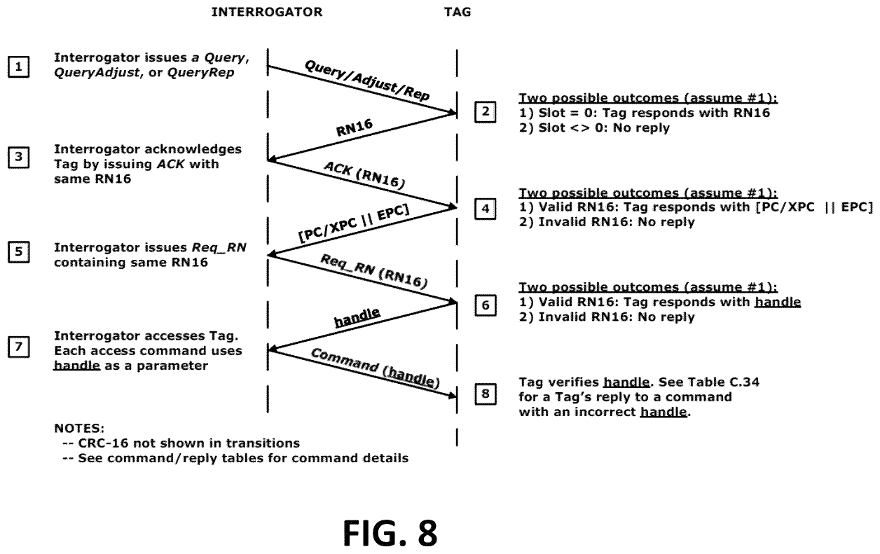

In Radio-Frequency Identification (RFID) design, inventory operation utilizes slot-based ALOHA, as shown in FIG. 8.

Step 1: Interrogator sends a Query command to a tag population, wherein the Query command indicates a Q value, indication of Selected/Select Flag (SL) flag selection, session indication, and Target indication of inventoried flag. One or more tags matching the indicated SL flag and inventoried flag will perform inventory operation and randomly generate a slot number among 0 to (2^{Q}−1) in response to the Query command. The interrogator may send one or more Select commands, before the Query command, to set SL flags and inventoried flags of the tag population based on condition on Memory Bank and mask bit-string indicated by each Select command. In other words, the Interrogator may select a tag sub-population to perform inventory operation, instead of full tag population. Besides, within one inventory round initialized by the Query command, the interrogator can send one or more Queryadjust commands to adjust the Q value and/or send one or more QueryRep commands for reducing the slot number of the tag sub-population.

Step 2: The one or more tags maintain their slot numbers and will reduce their slot number by 1 when receiving the QueryRep command from the Interrogator. When the slot number of a tag is equal to zero, the tag will send a randomly generated 16-bit, i.e., RN16, to the interrogator. In other words, the randomly generated slot numbers will normally distribute the tag sub-population into different slot occasions, such that the one or more tags of the tag sub-population will not send their RN16 at the same time with severe collision. Once more than one tag generates the same slot number, it will depend on the Interrogator implementation to distinguish them if feasible.

Step 3: When the Interrogator detects an RN16 signaling from a tag, the interrogator sends an Acknowledge/Acknowledgement (ACK) command with the detected RN16.

Step 4: The tag sending its RN16 in step 2 will detect or receive the ACK command in step 3. If the ACK command indicates the same RN16, the tag will be considered as acknowledged and will send its tag information to the interrogator, e.g., Electronic Product Code (EPC) or any code for identification. It is because the RN16 is just a temporary identity, the interrogator does not yet acquire real information for identifying the tag. If the ACK command does not indicate the same RN16, the tag will not be considered as acknowledged and will not reply anything.

Step 5: When interrogator receives the tag information for identifying the tag, it means that the interrogator inventories the tag successfully. If there is no need for further data delivery between the interrogator and the inventoried tag, the interrogator may send the QueryRep command to let other tags reduce their slot number, i.e., go back to step 1 for other tags. If there is a need for further data delivery between the interrogator and the inventoried tag, the interrogator will start an access operation and send the Req_RN command to the inventoried tag.

Step 6: When the tag receives the Req_RN command with the valid RN16 utilized in previous steps, the tag will start to perform the access operation and generate a new random 16-bit, denoted as handle, and send it to the interrogator. More specifically, the RN16 is a temporary identity for inventory operation, and the handle is an identity for access operation.

Step 7: After the interrogator acquires the handle from the inventoried tag, the interrogator can send one or more access commands to the tag for communication, e.g., scheduling data transmission from the tag to the interrogator, security management, tag's file management.

Step 8: When the tag receives an access command with a valid handle, the tag will report/reply accordingly. Note that step 7 and step 8 can be performed multiple times until the interrogator ends the communication (i.e., ends the access operation with the tag) by issuing any of Select, Challenge, Query, QueryX, QueryAdjust, QueryRep, or a Negative Acknowledge/Acknowledgement (NAK/NACK) command.

In NR, a network node (e.g., base station, Next Generation Node B (gNB)) may transmit Physical Downlink Control Channel (PDCCH) carrying Downlink Control Information (DCI) to a UE (e.g., device). The DCI may schedule/provide DL assignment such that the UE receives a DL transmission (e.g., Physical Downlink Shared Channel (PDSCH)) from the network node or may schedule/provide a UL grant such that the UE performs a UL transmission (e.g., Physical Uplink Shared Channel (PUSCH)) to the network node. Physical Resource Block (PRB)-based resource allocation in frequency domain is supported for PDSCH and PUSCH. One PRB comprises multiple Resource Elements (REs), e.g., one PRB consists of 12 REs. Note that the DL and UL are on Uu interface, which means the wireless interface for communication between network node and UE.

For NR sidelink, sidelink slots can be utilized for Physical Sidelink Control Channel (PSCCH)/Physical Sidelink Shared Channel (PSSCH)/Physical Sidelink Feedback Channel (PSFCH) transmission/reception. Moreover, a concept of sidelink resource pool for sidelink communication is utilized for PSCCH/PSSCH and/or PSFCH transmission/reception. A sidelink (communication) resource pool will comprise a set of sidelink slots (except at least slots for Physical Sidelink Broadcast Channel (PSBCH)) and a set of frequency resources. Different sidelink (communication) resource pools may be Time Division Multiplexed (TDMed) and Frequency-Division Multiplexed (FDMed). More specifically, a PSCCH in one sidelink (communication) resource pool can only schedule PSSCH resource(s) in the same one sidelink (communication) resource pool. A PSCCH in one sidelink (communication) resource pool is not able to schedule PSSCH resource(s) in other sidelink (communication) resource pool. For a PSCCH/PSSCH, associated PSFCH is in the same sidelink (communication) resource pool, instead of in different sidelink (communication) resource pools.

One sidelink (communication) resource pool will comprise multiple sub-channels in frequency domain, wherein a sub-channel comprises multiple consecutive PRBs in frequency domain. Configuration of the sidelink resource pool will indicate the number of PRBs of each sub-channel in the corresponding sidelink resource pool. Sub-channel based resource allocation in frequency domain is supported for PSSCH. For a PSSCH resource scheduled by a PSCCH in the same sidelink slot, a fixed relationship between the PSCCH and the PSSCH resource is specified, which means that the PSCCH will be located in the lowest (index of) sub-channel of the scheduled PSSCH resource. As for a scheduled PSSCH resource in different slot(s), a starting frequency position of the scheduled PSSCH resource will be scheduled/indicated by Sidelink Control Information (SCI), instead of a fixed relationship.

In current NR sidelink design, one SCI could indicate at most three PSSCH resources, for a same sidelink data packet, via Frequency resource assignment and/or Time resource assignment in the SCI. The SCI may comprise a 1st stage SCI and a 2nd stage SCI. The 1st stage SCI may be transmitted via PSCCH. The 2nd stage SCI may be transmitted via multiplexed with the scheduled PSSCH resource in the same sidelink slot, e.g., the first PSSCH resource. In other words, the SCI can schedule at most two PSSCH resources in later sidelink slots, e.g., the second PSSCH resource and/or the third PSSCH resource. The at most three PSSCH resources are in different slots in a sidelink (communication) resource pool. The at most three PSSCH resources are within 32 consecutive slots in a sidelink resource pool. The at most three PSSCH resources scheduled by the SCI are utilized/associated with a same sidelink data packet, e.g., a same Transport Block (TB) or a same Medium Access Control (MAC) Protocol Data Unit (PDU). Furthermore, a Transmission (TX) UE may transmit the same sidelink data packet via multiple PSSCH transmissions, e.g., the PSSCH 1 (the initial/new PSSCH transmission) and PSSCH 2˜6 (PSSCH retransmission). The TX UE may transmit SCI 1 in slot n₁ for indicating/scheduling PSSCH 1˜3. The TX UE may transmit SCI 2 in slot n₂ for indicating/scheduling PSSCH 2˜4. The TX UE may transmit SCI 3 in slot n₃ for indicating/scheduling PSSCH 3˜5. The TX UE may transmit SCI 4 in slot n₄ for indicating/scheduling PSSCH 4˜6. The TX UE may transmit SCI 5 in slot n₅ for indicating/scheduling PSSCH 5˜6. The TX UE may transmit SCI 6 in slot n₆ for indicating/scheduling PSSCH 6. For the same sidelink data packet, the TX UE may indicate/set the SCI 1˜6 with/as the same Hybrid Automatic Repeat Request (HARQ) process number, the same New Data Indicator (NDI) value, the same (Layer-1) source Identification (ID), the same (Layer-1) destination ID, and the same cast type. Note that standalone PSCCH/SCI is not supported in NR sidelink, which means that for each PSSCH transmission in a slot, there will be corresponding PSCCH/SCI transmission in the same slot, and vice versa.

Moreover, resource reservation for another/different TB by a SCI could be (pre-)configured with enabled or not enabled or not configured in a sidelink (communication) resource pool. When a sidelink (communication) resource pool is configured to enable such resource reservation, the sidelink (communication) resource pool is configured with a set of reservation period values. The possible reservation period could be 0, 1:99, 100, 200, 300, 400, 500, 600, 700, 800, 900, 1000 ms. The resource reservation period field in a SCI in the sidelink (communication) resource pool could indicate which reservation period value for (future) resource reservation. The size/number of the set of reservation period values could be from 1 to 16.

In NR sidelink design, there are two sidelink resource allocation modes defined for NR sidelink communication:
Mode 1 is that the base station/network node can schedule sidelink resource(s) to be used by the UE for sidelink transmission(s).
Mode 2 is that the UE determines (i.e. base station/network node does not schedule) sidelink transmission resource(s) within sidelink resources configured by the network node or pre-configured.

For UE (autonomous) selection mode, e.g., NR sidelink resource allocation mode 2, since a transmission resource is not scheduled via the network node, the UE may require performing sensing before selecting one or more resources for PSSCH transmission(s) (e.g., sensing-based transmission), in order to avoid resource collision and interference from or to other UEs (especially UEs using NR sidelink). Full sensing is supported from NR Rel-16 sidelink, while partial sensing is supported from NR Rel-17 sidelink. Based on a result of a sensing procedure, the UE can determine a valid/identified resource set. The valid/identified resource set may be reported to higher layers (of the UE). The UE may (randomly) select one or multiple valid/identified resources from the valid/identified resource set to perform sidelink transmission(s) from the UE. The sidelink transmission(s) from the UE may be a PSCCH and/or PSSCH transmission.

For network scheduling mode, e.g., NR sidelink resource allocation mode 1, dynamic grant, configured grant Type 1, and configured grant Type 2 are supported in [7] 3GPP TS 38.214 V18.2.0. Regarding dynamic grant, the network node may transmit a Sidelink (SL) grant, e.g., DCI format 3_0 scrambled by SL-Radio Network Temporary Identifier (RNTI), on Uu interface for scheduling at most three PSSCH resources (for a same sidelink data packet) to a TX UE. The sidelink grant also comprises a “resource pool index” for indicating one sidelink (communication) resource pool, wherein the scheduled at most three PSCCH/PSSCH resources are within the indicated one sidelink (communication) resource pool. The TX UE may perform PSCCH and PSSCH transmissions on PC5 interface, in response to the received sidelink grant, for a sidelink data packet. For instance, the TX UE may receive a first sidelink grant indicating three resources for performing PSSCH 1˜3 transmissions for transmitting the same sidelink data packet. The TX UE may receive a second sidelink grant indicating another three resources for performing PSSCH 4˜6 transmissions for transmitting the same sidelink data packet. The network may provide the second sidelink grant if the TX UE indicates need of retransmission resources. The network may indicate/set the same SL HARQ process number and the same NDI value in the first sidelink grant and the second sidelink grant, so the TX UE can know that the first sidelink grant and the second sidelink grant are utilized for the same sidelink data packet.

Note that the SL on PC5 interface means the wireless interface for communication (directly) between UEs/devices.

Moreover, decoding of a sidelink data packet in Reception (RX) UE can support HARQ combining from received multiple PSSCH transmissions. The sidelink data packet can be SL HARQ feedback enabled or disabled. If the sidelink data packet is SL HARQ feedback enabled, the RX UE may transmit NACK on PSFCH to the TX UE if the RX UE does not yet decode the sidelink data packet successfully. The RX UE may transmit ACK (including to not transmit feedback in NACK-only feedback mode) on PSFCH to the TX UE if the RX UE decodes the sidelink data packet successfully. When the TX UE receives/detects NACK, the TX UE may perform a PSSCH retransmission for transmitting the same sidelink data packet, via the selected SL resources, if any, in NR sidelink resource allocation mode 2 or via scheduled/configured SL resources by a SL grant, if any, in NR sidelink resource allocation mode 1. Note that in NR sidelink resource allocation mode 2, if the TX UE utilizes all selected SL resources for performing PSSCH retransmissions for the sidelink data packet and if the TX UE still receives/detects NACK, the TX UE may not be able to perform another/other PSSCH retransmission for transmitting the same sidelink data packet. When the TX UE receives/detects ACK, the TX UE may stop performing PSSCH retransmission even if there are un-utilized selected or scheduled/configured SL resources for the sidelink data packet.

For ambient IoT in NR, it is possible to consider RFID as starting point for designing access procedures and communication operations. Note that in a terminology aspect, an access procedure for ambient IoT may be more like an inventory operation in RFID, not an access operation in RFID. The communication operation for ambient IoT may be more like an access operation in RFID. The detailed design will be different between RFID and ambient IoT. Moreover, a network/intermediate node in NR may operate with similar functionality/functionalities as an interrogator in RFID. Ambient IoT device/UE in NR may operate with similar functionality/functionalities as a tag in RFID.

In Deployment scenario 2 with Topology 2 (D2T2) (e.g., [2] RP-240826 and [3] 3GPP TR 38.848 V18.0.0), the intermediate node may operate as a reader, wherein the intermediate node can be a UE under network control. In other words, resources utilized for Reader to (Ambient IoT) Device (R2D) and (Ambient IoT) Device to Reader (D2R) between the intermediate node and ambient IoT device(s)/UE(s) should be under network control. If a carrier wave is also inside topology, resources utilized for the carrier wave should be under network control as well.

To support scenario D2T2, the main issues are how the intermediate node acquires resources from the network and how the network allocates resources to the intermediate node. Although sidelink operation is designed for communication on PC5 interface between UEs or devices, there are some differences from ambient IoT device(s)/UE(s). For an instance, the intermediate node can perform R2D transmission such that start of the R2D transmission aligns with the boundary of an NR Orthogonal Frequency-Division Multiplexing (OFDM) symbol (including the Cyclic Prefix (CP)). Start of NR sidelink transmission from sidelink UE(s) can also align with the boundary of an NR OFDM symbol. However, due to Sampling Frequency Offset (SFO), ambient IoT device(s)/UE(s) are hard to achieve such alignment. Thus, the intermediate node and even the network cannot fully/accurately control start of each D2R transmission in time domain. For another instance, resources amount required for NR sidelink transmissions from a sidelink TX UE can be predictable, since it only needs to consider the sidelink data buffer of the sidelink TX UE. However, the intermediate node may not exactly know how many ambient IoT device(s)/UE(s) will be served or inventoried, especially the inventory procedure or contention-based access procedure will not be counted/considered in the sidelink data buffer of the intermediate node. Thus, the resources amount required for ambient IoT transmissions/receptions for the intermediate node will be hard to predict, such that the network will be hard to allocate resources to the intermediate node.

To deal with the above and herein issues, some concepts, aspects, mechanisms, methods, and embodiments are provided below.

### Concept A

In concept A, a network node may allocate/schedule/assign/provide/indicate a set of resources, via one or more DL signaling(s), for/to an intermediate node. When the intermediate node receives the one or more DL signaling(s), the intermediate node may derive/determine the set of resources. Preferably in certain embodiments, the set of resources may be utilized by the intermediate node for ambient IoT-related operation. Preferably in certain embodiments, the set of resources may be utilized for R2D transmission and/or D2R transmission and/or carrier wave transmission. Preferably in certain embodiments, the R2D transmission means a transmission from the intermediate node to (ambient IoT or A-IoT)) UE(s)/device(s). Preferably in certain embodiments, the D2R transmission means a transmission from (ambient IoT) UE(s)/device(s) to the intermediate node. Preferably in certain embodiments, the carrier wave transmission may be transmitted from the intermediate node for (ambient IoT) UE(s)'s/device(s)'s backscattered D2R transmission.

In one embodiment A1, the set of resources may be one or more resources in time and/or frequency domain. Preferably in certain embodiments, the one or more resources may be aperiodic or one-shot. Preferably in certain embodiments, the one or more resources may be allocated/scheduled/assigned/provided/indicated via a dynamic grant.

Preferably in certain embodiments, the one or more resources may be located in consecutive Transmission Time Intervals (TTIs). Preferably in certain embodiments, the one or more DL signaling(s) may indicate a starting timing and a number of consecutive TTIs of the one or more resources. Preferably or alternatively in certain embodiments, the one or more DL signaling(s) may indicate a starting timing and an ending timing of the one or more resources. Preferably in certain embodiments, the one or more DL signaling(s) may indicate a first time offset for deriving/determining the starting timing. Preferably in certain embodiments, the one or more DL signaling(s) may indicate a first time duration for deriving/determining the number of consecutive TTIs or a number of the one or more resources. Preferably in certain embodiments, the number of the one or more resources is the same as the number of consecutive TTIs.

Preferably in certain embodiments, the one or more DL signaling(s) may be/comprise one or more downlink control information.

Preferably in certain embodiments, after (utilization of) the one or more resources, the intermediate node may provide/transmit a report or a feedback to the network node. The intermediate node may indicate, via the report or the feedback, whether there is a need of more resources. For instance, if the intermediate node needs more resources, the intermediate node may indicate the need of more resources or indicate a NACK. If the intermediate node does not need more resources, the intermediate node may indicate no need of more resources or indicate an ACK. Preferably in certain embodiments, when the network node receives/detects the report or the feedback, the network may determine whether to allocate/schedule/assign/provide/indicate another set of resources for the intermediate node. Preferably in certain embodiments, the one or more DL signaling(s) may indicate a UL resource for the intermediate node to provide/transmit the report or the feedback.

In one embodiment A2, the set of resources may be periodic resources (in time and/or frequency domain) comprising one or more resources in one/each period. Preferably in certain embodiments, the set of resources may mean/comprise the one or more resources in each period with a periodicity. Preferably in certain embodiments, the set of resources may be allocated/scheduled/assigned/provided/indicated via a (type-1 or type-2) configured grant. Preferably in certain embodiments, the set of resources may be semi-persistent allocated/scheduled/assigned/provided/indicated.

Preferably in certain embodiments, the one or more resources may be located in consecutive TTIs. Preferably in certain embodiments, the one or more DL signaling(s) may indicate a starting timing and a number of consecutive TTIs of the one or more resources. Preferably or alternatively in certain embodiments, the one or more DL signaling(s) may indicate a starting timing and an ending timing of the one or more resources. Preferably in certain embodiments, the one or more DL signaling(s) may indicate a first time offset for deriving/determining the starting timing. Preferably in certain embodiments, the one or more DL signaling(s) may indicate a first time duration for deriving/determining the number of consecutive TTIs or a number of the one or more resources. Preferably in certain embodiments, the number of the one or more resources is the same as the number of consecutive TTIs.

Preferably in certain embodiments, the one or more DL signaling(s) may be/comprise one or more configured grant configurations. Preferably in certain embodiments, the set of resources may be allocated/scheduled/assigned/provided/indicated via a type-1 configured grant. Preferably in certain embodiments, the one or more configured grant configurations may allocate/schedule/assign/provide/indicate the one or more resources and the periodicity.

Preferably or alternatively in certain embodiments, the one or more DL signaling(s) may be/comprise one or more configured grant configurations and one or more downlink control information for activation, e.g., a type-2 configured grant. The intermediate node may receive the one or more configured grant configurations via system information or a dedicated configuration transmitted/provided from the network node (beforehand). When (or in response to) the intermediate node receives the one or more downlink control information for activation, the intermediate node may start to determine/utilize the set of resources for ambient IoT-related operation. Preferably in certain embodiments, the one or more configured grant configurations may allocate/schedule/assign/provide/indicate the periodicity. The one or more downlink control information for activation may allocate/schedule/assign/provide/indicate the one or more resources.

Preferably in certain embodiments, when (or in response to) the intermediate node receives another one or more downlink control information for deactivation/release, the intermediate node may release/deactivate the set of resources and/or terminate the utilization of the set of resources for ambient IoT-related operation.

Preferably in certain embodiments, after (utilization of) the one or more resources in one/each period, the intermediate node may provide/transmit a report or a feedback to the network node (in the one/each period) (e.g., before the one or more resources in a next period). The intermediate node may indicate, via the report or the feedback, whether there is a need of keeping resources. For instance, if the intermediate node needs to keep (utilization of) the set of resources, the intermediate node may indicate the need of keeping resources or indicate a NACK/keep. If the intermediate node does not need (utilization of) the set of resources, the intermediate node may indicate no need of keeping resources or indicate an ACK/release. Preferably in certain embodiments, the intermediate node may terminate the utilization of the set of resources for ambient IoT-related operation after the intermediate node indicates no need of keeping resources or indicates the ACK/release. Preferably in certain embodiments, when the network node receives/detects the report or the feedback, the network may determine whether to transmit the another one or more downlink control information for deactivation/release to the intermediate node. Preferably in certain embodiments, the intermediate node may terminate the utilization of the set of resources for ambient IoT-related operation after the intermediate node receives another one or more downlink control information for deactivation/release. Preferably in certain embodiments, the one or more DL signaling(s) may indicate a UL resource (in one/each period) for the intermediate node to provide/transmit the report or the feedback.

Alternatively in certain embodiments, for embodiment A1 and A2, the one or more resources may be located in separate TTIs as allocated/scheduled/assigned/provided/indicated by the one or more DL signaling(s), e.g., no limitation of consecution in time domain. Preferably in certain embodiments, the one or more DL signaling(s) may indicate each TTI of the one or more resources. Preferably in certain embodiments, the one or more DL signaling(s) may indicate a first/initial TTI for a first/initial resource among the one or more resources. Preferably in certain embodiments, the one or more DL signaling(s) may indicate a second time offset, between a second TTI and the first/initial TTI, for a second resource among the one or more resources. Preferably in certain embodiments, the one or more DL signaling(s) may indicate a third time offset, between a third TTI and the first/initial TTI or between the third TTI and the second TTI, for a third resource among the one or more resources. Preferably in certain embodiments, the one or more resources may be restricted within a second time duration. The second time duration may be counted/derived/calculated starting from the first/initial TTI.

Preferably in certain embodiments, the one or more resources may be the same (i.e. occupy the same frequency resources) in frequency domain. Preferably in certain embodiments, the one or more DL signaling(s) may indicate a starting frequency resource and a number of consecutive frequency resources for the one or more resources. Preferably or alternatively in certain embodiments, the one or more DL signaling(s) may indicate a starting frequency resource and an ending frequency resource for the one or more resources.

Alternatively in certain embodiments, the one or more resources may be the same or different in frequency domain as allocated/scheduled/assigned/provided/indicated by the one or more DL signaling(s), e.g., no limitation of the same frequency resources in frequency domain. Preferably in certain embodiments, the one or more DL signaling(s) may indicate a first starting frequency resource and a first number of consecutive frequency resources for a first/initial resource among the one or more resources. Preferably in certain embodiments, the one or more DL signaling(s) may indicate a second starting frequency resource and a second number of consecutive frequency resources for a second resource among the one or more resources. Preferably or alternatively in certain embodiments, the first number of consecutive frequency resources may be the same as the second number of consecutive frequency resources. The one or more resources may occupy the same number of frequency resources with the same or different starting frequency resources.

Preferably in certain embodiments, the (first/second) number of consecutive frequency resources may be utilized for one or more R2D transmissions or one or more D2R transmissions (in the same timing). Preferably in certain embodiments, the number of consecutive frequency resources may comprise one or more transmissions/occupied bandwidths for R2D transmission. Preferably in certain embodiments, the number of consecutive frequency resources may comprise one or more transmissions/occupied bandwidths for D2R transmission.

In one embodiment A3, the set of resources may be a resource pool comprising multiple resources (in time and/or frequency domain). Preferably in certain embodiments, the resource pool may be dedicated for ambient IoT-related operation. Preferably in certain embodiments, the resource pool may comprise a number of consecutive frequency resources in associated multiple TTIs.

Preferably in certain embodiments, the one or more DL signaling(s) may indicate a starting frequency resource and the number of consecutive frequency resources for the resource pool. Preferably or alternatively in certain embodiments, the one or more DL signaling(s) may indicate a starting frequency resource and an ending frequency resource for the resource pool. Preferably in certain embodiments, the number of consecutive frequency resources may be utilized for one or more R2D transmissions or one or more D2R transmissions (in the same timing). Preferably in certain embodiments, the number of consecutive frequency resources may comprise one or more transmissions/occupied bandwidths for R2D transmission. Preferably in certain embodiments, the number of consecutive frequency resources may comprise one or more transmissions/occupied bandwidths for D2R transmission.

Preferably in certain embodiments, the one or more DL signaling(s) may indicate the associated multiple TTIs.

Preferably in certain embodiments, the resource pool may be located in consecutive TTIs. The associated multiple TTIs may be the consecutive TTIs. Preferably in certain embodiments, the one or more DL signaling(s) may indicate a starting timing and a number of consecutive TTIs of the resource pool. Preferably or alternatively in certain embodiments, the one or more DL signaling(s) may indicate a starting timing and an ending timing of the resource pool. Preferably in certain embodiments, the one or more DL signaling(s) may indicate a first time offset for deriving/determining the starting timing. Preferably in certain embodiments, the one or more DL signaling(s) may indicate a first time duration for deriving/determining the number of consecutive TTIs or the associated multiple TTIs.

Preferably in certain embodiments, the one or more DL signaling(s) may be/comprise one or more resource pool configurations.

Preferably or alternatively in certain embodiments, the one or more DL signaling(s) may be/comprise one or more resource pool configurations and one or more downlink control information. Preferably in certain embodiments, the one or more downlink control information may indicate one resource pool.

Preferably in certain embodiments, the one or more downlink control information may activate utilization of the one indicated resource pool, e.g., the set of resources is the one resource pool. When the intermediate node receives the one or more downlink control information for activation, the intermediate node may start to determine/utilize the set of resources for ambient IoT-related operation.

Preferably or alternatively in certain embodiments, the one or more downlink control information may allocate/schedule/assign/provide/indicate one or more (dynamic or aperiodic) resources within the indicated one resource pool, e.g., the set of resources is the one or more (dynamic or aperiodic) resources within the indicated one resource pool (an embodiment of combining A1 and A3).

Preferably or alternatively in certain embodiments, the one or more downlink control information may (activate a configured grant and) allocate/schedule/assign/provide/indicate one or more periodic resources within the indicated one resource pool, e.g., the set of resources is the one or more periodic resources within the indicated one resource pool (an embodiment of combining A2 and A3).

Preferably in certain embodiments, the intermediate node may receive the one or more resource pool configurations via system information or a dedicated configuration transmitted/provided from the network node (beforehand). When the intermediate node receives the one or more downlink control information, the intermediate node may start to determine/utilize part or all of the set of resources for ambient IoT-related operation.

Preferably in certain embodiments, when the intermediate node receives another one or more downlink control information for deactivation/release, the intermediate node may release/deactivate the set of resources and/or terminate the utilization of the set of resources for ambient IoT-related operation. Preferably in certain embodiments, when the intermediate node receives the another one or more downlink control information for deactivation/release, the intermediate node may release/deactivate the one resource pool and/or terminate the utilization of the one resource pool for ambient IoT-related operation.

Preferably in certain embodiments, after (utilization of) the resource pool, the intermediate node may provide/transmit a report or a feedback to the network node (e.g., periodically). The intermediate node may indicate, via the report or the feedback, whether there is a need of keeping resources. For instance, if the intermediate node needs to keep (utilization of) the resource pool, the intermediate node may indicate the need of keeping resources or indicate a NACK/keep. If the intermediate node does not need (utilization of) the resource pool, the intermediate node may indicate no need of keeping resources or indicate an ACK/release. Preferably in certain embodiments, the intermediate node may terminate the utilization of the set of resources for ambient IoT-related operation after the intermediate node indicates no need of keeping resources or indicates the ACK/release. Preferably in certain embodiments, when the network node receives/detects the report or the feedback, the network may determine whether to transmit the another one or more downlink control information for deactivation/release to the intermediate node. Preferably in certain embodiments, the intermediate node may terminate the utilization of the set of resources for ambient IoT-related operation after the intermediate node receives the another one or more downlink control information for deactivation/release. Preferably in certain embodiments, the one or more DL signaling(s) may indicate a UL (periodic) resource for the intermediate node to provide/transmit the report or the feedback. Preferably or alternatively in certain embodiments, a resource pool configuration of the indicated one resource pool may indicate a UL (periodic) resource for the intermediate node to provide/transmit the report or the feedback.

In one embodiment A4, the set of resources may be one or multiple frequency (sub-)bands comprising multiple resources (in time and/or frequency domain). Preferably in certain embodiments, the one or multiple frequency (sub-)bands may be dedicated for ambient IoT-related operation. Preferably in certain embodiments, a frequency (sub-)band of the one or multiple frequency (sub-)bands may comprise a number of consecutive frequency resources. The one or multiple frequency (sub-)bands may comprise one or multiple frequency (sub-)bands for R2D. The one or multiple frequency (sub-)bands may comprise one or multiple frequency (sub-)bands for D2R. The one or multiple frequency (sub-)bands for R2D and the one or multiple frequency (sub-)bands for D2R may be in the same band, e.g., in-band to NR, in guard-band to Long-Term

Evolution (LTE)/NR, or in standalone band(s). The one or multiple frequency (sub-)bands for R2D and the one or multiple frequency (sub-)bands for D2R may be in different bands, e.g., in-band to NR for D2R (or R2D) and in guard-band to LTE/NR for R2D (or D2R).

Preferably in certain embodiments, the one or more DL signaling(s) may indicate a starting frequency resource and the number of consecutive frequency resources for the frequency (sub-)band. Preferably or alternatively in certain embodiments, the one or more DL signaling(s) may indicate a starting frequency resource and an ending frequency resource for the frequency (sub-)band.

Preferably in certain embodiments, the one or more DL signaling(s) may indicate associated multiple TTIs for utilization of the frequency (sub-)band. Preferably in certain embodiments, the number of consecutive frequency resources may be utilized for one or more R2D transmissions or one or more D2R transmissions (in the same timing). Preferably in certain embodiments, the number of consecutive frequency resources may comprise one or more transmissions/occupied bandwidths for R2D transmission. Preferably in certain embodiments, the number of consecutive frequency resources may comprise one or more transmissions/occupied bandwidths for D2R transmission.

Preferably in certain embodiments, the associated multiple TTIs may be a number of consecutive TTIs. Preferably in certain embodiments, the one or more DL signaling(s) may indicate a starting timing and also the number of consecutive TTIs for utilization of the frequency (sub-)band. Preferably or alternatively in certain embodiments, the one or more DL signaling(s) may indicate a starting timing and an ending timing for utilization of the frequency (sub-)band. Preferably in certain embodiments, the one or more DL signaling(s) may indicate a first time offset for deriving/determining the starting timing. Preferably in certain embodiments, the one or more DL signaling(s) may indicate a first time duration for deriving/determining the number of consecutive TTIs or the associated multiple TTIs for utilization of the frequency (sub-)band.

Preferably in certain embodiments, the one or more DL signaling(s) may be/comprise one or more frequency (sub-)band configurations.

Preferably or alternatively in certain embodiments, the one or more DL signaling(s) may be/comprise one or more frequency (sub-)band configurations and one or more downlink control information. Preferably in certain embodiments, the one or more downlink control information may indicate one frequency (sub-)band.

Preferably in certain embodiments, the one or more downlink control information may activate utilization of the one frequency (sub-)band, e.g., the set of resources is the one frequency (sub-)band. When the intermediate node receives the one or more downlink control information for activation, the intermediate node may start to determine/utilize the set of resources for ambient IoT-related operation.

Preferably or alternatively in certain embodiments, the one or more downlink control information may allocate/schedule/assign/provide/indicate one or more (dynamic or aperiodic) resources within the indicated one frequency (sub-)band, e.g., the set of resources is the one or more (dynamic or aperiodic) resources within the indicated one frequency (sub-)band (an embodiment of combining A1 and A4).

Preferably or alternatively in certain embodiments, the one or more downlink control information may (activate a configured grant and) allocate/schedule/assign/provide/indicate one or more periodic resources within the indicated one frequency (sub-)band, e.g., the set of resources is the one or more periodic resources within the indicated one frequency (sub-)band (an embodiment of combining A2 and A4).

Alternatively in certain embodiments, for embodiment A3 and A4, the associated multiple TTIs may be located in separate TTIs as allocated/scheduled/assigned/provided/indicated by the one or more DL signaling(s), e.g., no limitation of consecution in time domain. Preferably in certain embodiments, the one or more DL signaling(s) may indicate each TTI of the associated multiple TTIs. Preferably in certain embodiments, the one or more DL signaling(s) may indicate a first/initial TTI among the associated multiple TTIs. Preferably in certain embodiments, the one or more DL signaling(s) may indicate a second time offset, between a second TTI and the first/initial TTI, for a second TTI among the associated multiple TTIs. Preferably in certain embodiments, the one or more DL signaling(s) may indicate a third time offset, between a third TTI and the first/initial TTI or between the third TTI and the second TTI, for a third TTI among the associated multiple TTIs. Preferably in certain embodiments, the associated multiple TTIs may be restricted within a second time duration. The second time duration may be counted/derived/calculated starting from the first/initial TTI.

Preferably in certain embodiments, the intermediate node may receive the one or more frequency (sub-)band configurations via system information or a dedicated configuration transmitted/provided from the network node (beforehand). When the intermediate node receives the one or more downlink control information, the intermediate node may start to determine/utilize part or all of the set of resources for ambient IoT-related operation.

Preferably in certain embodiments, when the intermediate node receives another one or more downlink control information for deactivation/release, the intermediate node may release/deactivate the set of resources and/or terminate the utilization of the set of resources for ambient IoT-related operation. Preferably in certain embodiments, when the intermediate node receives the another one or more downlink control information for deactivation/release, the intermediate node may release/deactivate the one frequency (sub-)band and/or terminate the utilization of the one frequency (sub-)band for ambient IoT-related operation.

Preferably in certain embodiments, after (utilization of) the frequency (sub-)band, the intermediate node may provide/transmit a report or a feedback to the network node (e.g., periodically). The intermediate node may indicate, via the report or the feedback, whether there is a need of keeping resources. For instance, if the intermediate node needs to keep (utilization of) the frequency (sub-)band, the intermediate node may indicate the need of keeping resources or indicate a NACK/keep. If the intermediate node does not need (utilization of) the frequency (sub-)band, the intermediate node may indicate no need of keeping resources or indicate an ACK/release. Preferably in certain embodiments, the intermediate node may terminate the utilization of the set of resources for ambient IoT-related operation after the intermediate node indicates no need of keeping resources or indicate the ACK/release. Preferably in certain embodiments, when the network node receives/detects the report or the feedback, the network may determine whether to transmit the another one or more downlink control information for deactivation/release to the intermediate node. Preferably in certain embodiments, the intermediate node may terminate the utilization of the set of resources for ambient IoT-related operation after the intermediate node receives the another one or more downlink control information for deactivation/release. Preferably in certain embodiments, the intermediate node may terminate the utilization of the set of resources for ambient IoT-related operation after the intermediate node receives another one or more downlink control information for deactivation/release. Preferably in certain embodiments, the one or more DL signaling(s) may indicate a UL (periodic) resource for the intermediate node to provide/transmit the report or the feedback. Preferably or alternatively in certain embodiments, frequency (sub-)band configuration of the indicated one frequency (sub-)band may indicate a UL (periodic) resource for the intermediate node to provide/transmit the report or the feedback.

Preferably in certain embodiments, a (starting/ending) frequency resource may be/mean or include a (starting/ending) PRB, a (starting/ending) subcarrier, a (starting/ending) sub-channel, or a (starting/ending) unit of frequency resource.

Preferably in certain embodiments, the number of consecutive frequency resources may be/mean or include a number of consecutive PRBs, a number of consecutive subcarriers, a number of consecutive sub-channels, or a number of consecutive units of frequency resources.

Preferably in certain embodiments, a (starting/ending) timing may be/mean or include a (starting/ending) (OFDM) symbol, a (starting/ending) specific number of (OFDM) symbols, a (starting/ending) sub-slot, a (starting/ending) slot, a (starting/ending) subframe, a (starting/ending) millisecond, or a (starting/ending) unit of time resource.

Preferably in certain embodiments, the TTI may be/mean or include a (OFDM) symbol, a specific number of (OFDM) symbols, a sub-slot, a slot, a subframe, a millisecond, or a unit of time resource. Preferably in certain embodiments, the set of resources may be in-band to NR or in guard-band to LTE/NR or in intra-cell guard band.

Preferably in certain embodiments, the one or more DL signaling(s) may indicate the set of resources being in-band to NR or in guard-band to LTE/NR. Preferably in certain embodiments, the one or more DL signaling(s) may indicate the set of resources being inside cell bandwidth or outside cell bandwidth.

Preferably in certain embodiments, the intermediate UE operates in Radio Resource Control (RRC)-connected mode. Preferably in certain embodiments, the intermediate UE operates in a RRC mode for performing intermediate node operation/functionality.

Preferably in certain embodiments, the intermediate UE may utilize the set of resources for performing a contention-based access procedure, contention-free access procedure, inventory procedure/operation, and/or communication procedure/operation.

Preferably in certain embodiments, the intermediate UE may utilize the set of resources for one or more (ambient IoT) UEs/devices.

Preferably in certain embodiments, in Frequency Division Duplex (FDD) operation, the network node may transmit the one or more DL signaling(s) in a DL band of one cell or a DL cell. Preferably in certain embodiments, the intermediate node may transmit the report or the feedback in a UL band of the one cell or a UL cell. Preferably in certain embodiments, the set of resources may be in a UL band of the one cell or a UL cell. The ambient IoT-related operation may be performed in the UL band of the one cell or the UL cell.

Preferably in certain embodiments, in FDD operation, the cell bandwidth may comprise the DL band and the UL band. Preferably in certain embodiments, the DL band may mean/be or replaced as DL Bandwidth Part (BWP) or DL cell bandwidth. The UL band may mean/be or replaced as UL BWP or UL cell bandwidth.

Preferably in certain embodiments, in Time Division Duplex (TDD) operation, the network node may transmit the one or more DL signaling(s) in a DL symbol(s) of one cell. Preferably in certain embodiments, the intermediate node may transmit the report or the feedback in a UL symbol(s) of the one cell. Preferably in certain embodiments, the set of resources may be in a UL symbol(s) of the one cell. The ambient IoT-related operation may be performed in the UL symbol(s) of the one cell. Preferably or alternatively in certain embodiments, the set of resources may be in a UL symbol(s) of the one cell and/or DL symbol(s) of the one cell. The ambient IoT-related operation may be performed in the UL symbol(s) of the one cell and/or DL symbol(s) of the one cell. In other words, there may be no DL/UL differentiation within the set of resources. Preferably in certain embodiments, in TDD operation, the cell bandwidth may comprise one cell bandwidth for DL and UL. Preferably in certain embodiments, the cell bandwidth may mean/be or replaced as a (DL/UL) BWP.

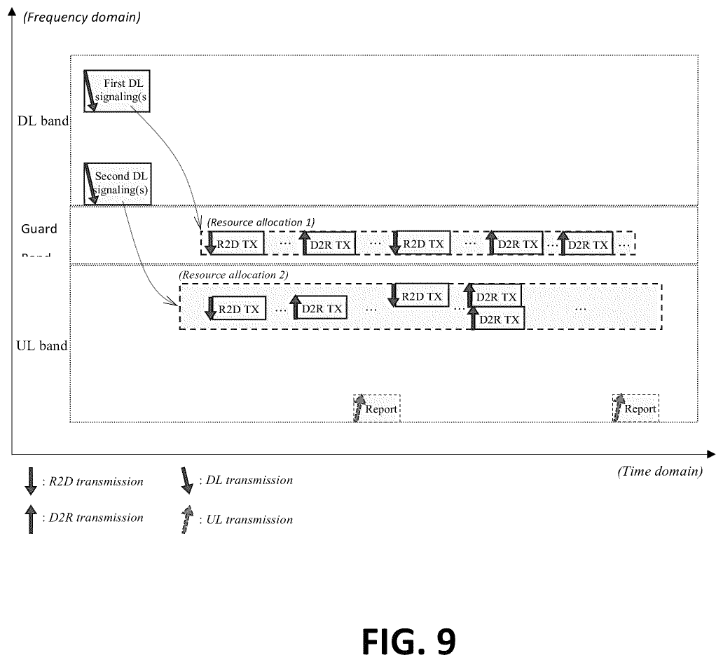

FIG. 9 shows an instance that a cell is operated in FDD. The cell may comprise a DL band and a UL band. From the intermediate node's aspect, the cell may comprise a DL BWP (within the DL band) and a UL BWP (within the UL band). The intermediate node may receive some DL signaling(s) in the DL band or the DL BWP.

In the case of FIG. 9, the intermediate node may derive/determine resource allocation 1 via first one or more DL signaling(s). As shown in FIG. 9, the resource allocation 1 may be a first resource pool or a first frequency (sub-)band which comprises a number of consecutive frequency resources in a guard band. Note that the guard band may be between the DL band and the UL band (as shown in FIG. 9) or in the upper outer side of the DL band or in the lower outer side of the UL band. Note that the resource allocation 1 may be in consecutive physical TTIs or in consecutive logical TTIs. The logical TTIs may be/mean TTIs associated/assigned/indicated with the resource allocation 1. Consecutive logical TTIs does not mean consecutive in physical TTIs.

In the case of FIG. 9, the intermediate node may derive/determine resource allocation 2 via second one or more DL signaling(s). As shown in FIG. 9, the resource allocation 2 may be a second resource pool or a second frequency (sub-)band which comprises a number of consecutive frequency resources in a UL band. Note that the resource allocation 2 may be in consecutive physical TTIs or in consecutive logical TTIs. The logical TTIs may be/mean TTIs associated/assigned/indicated with the resource allocation 2. Consecutive logical TTIs does not mean consecutive in physical TTIs.

The intermediate node may perform one or more R2D transmissions within the first/second resource pool or the first/second frequency (sub-)band. The intermediate node may receive one or more D2R transmissions from (ambient IoT) UE(s)/device(s) within the first/second resource pool or the first/second frequency (sub-)band. The intermediate node may perform ambient IoT-related operation, e.g., a contention-based access procedure, contention-free access procedure, inventory procedure/operation, and/or communication procedure/operation, within the first/second resource pool or the first/second frequency (sub-)band. Preferably in certain embodiments, the intermediate node may transmit one or more report in UL band, e.g., after or in response to receiving the first/second one or more DL signaling(s) or (starting) utilization of the resource allocation 1/2. The intermediate node may transmit a report (e.g., the left Report shown in the FIG. 9) for indicating a need of (keeping) the resource allocation 1/2. The intermediate node may transmit a report (e.g., the right Report shown in the FIG. 9) for indicating no need of (keeping) the resource allocation 1/2. Preferably in certain embodiments, the intermediate node may terminate the utilization of the resource allocation 1/2 for ambient IoT-related operation after the intermediate node indicates no need of (keeping) the resource allocation 1/2 or after the intermediate node receives the another one or more downlink control information for deactivating/releasing the resource allocation 1/2.

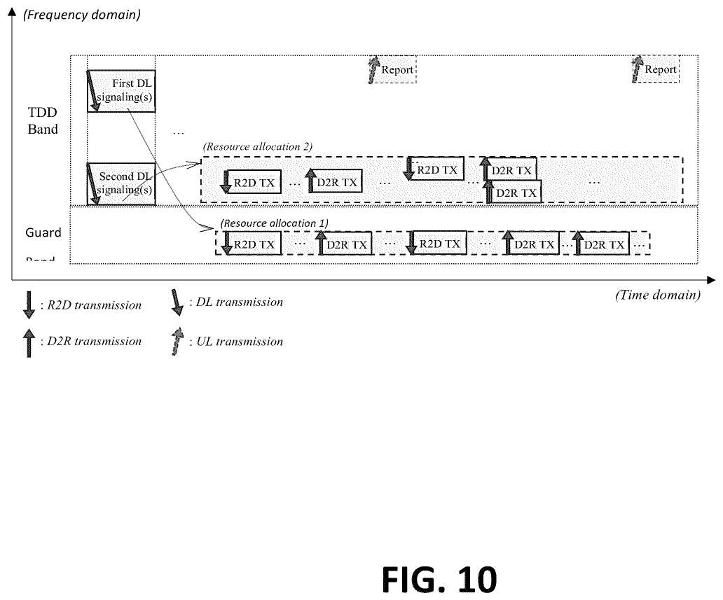

FIG. 10 shows an instance that a cell is operated in TDD. The cell may comprise a TDD band. From intermediate node's aspect, the cell may comprise a DL BWP (within the TDD band) and a UL BWP (within the TDD band). The DL BWP may be the same with the UL BWP (e.g., center frequency of the DL BWP and the UL BWP are the same, and PRBs comprised in the DL BWP and the UL BWP are the same). The intermediate node may receive some DL signaling(s) in (DL symbols of) the TDD band or DL BWP.

In the case of FIG. 10, the intermediate node may derive/determine resource allocation 1 via first one or more DL signaling(s). As shown in FIG. 10, the resource allocation 1 may be a first resource pool or a first frequency (sub-)band which comprises a number of consecutive frequency resources in a guard band. Note that the guard band may be in the lower outer side of the TDD band (as shown in FIG. 10) or in the upper outer side of the TDD band. Preferably in certain embodiments, the resource allocation 1 may be in consecutive physical TTIs (e.g., the resource allocation 1 may comprise DL symbols and UL symbols in time domain, or the intermediate node may utilize the resource allocation 1 without considering DL or UL symbols in time domain). Preferably or alternatively in certain embodiments, the resource allocation 1 may be in consecutive logical TTIs. The logical TTIs may be/means TTIs associated/assigned/indicated with the resource allocation 1. The logical TTIs may comprise UL symbols and/or flexible symbols. The logical TTIs may not comprise DL symbols. Consecutive logical TTIs does not mean consecutive in physical TTIs.

In the case of FIG. 10, the intermediate node may derive/determine resource allocation 2 via second one or more DL signaling(s). As shown in FIG. 10, the resource allocation 2 may be a second resource pool or a second frequency (sub-)band which comprises a number of consecutive frequency resources in the TDD band. Preferably in certain embodiments, the resource allocation 2 may be in consecutive physical TTIs (e.g., the resource allocation 2 may comprise DL symbols and UL symbols in time domain, or the intermediate node may utilize the resource allocation 2 without considering DL or UL symbols in time domain). Preferably or alternatively in certain embodiments, the resource allocation 2 may be in consecutive logical TTIs. The logical TTIs may be/means TTIs associated/assigned/indicated with the resource allocation 2. The logical TTIs may comprise UL symbols and/or flexible symbols. The logical TTIs may not comprise DL symbols. Consecutive logical TTIs does not mean consecutive in physical TTIs.

The intermediate node may perform one or more R2D transmissions within the first/second resource pool or the first/second frequency (sub-)band. The intermediate node may receive one or more D2R transmissions from (ambient IoT) UE(s)/device(s) within the first/second resource pool or the first/second frequency (sub-)band. The intermediate node may perform ambient IoT-related operation, e.g., a contention-based access procedure, contention-free access procedure, inventory procedure/operation, and/or communication procedure/operation, within the first/second resource pool or the first/second frequency (sub-)band. Preferably in certain embodiments, the intermediate node may transmit one or more reports in (UL symbols of) the TDD band, e.g., after or in response to receiving the first/second one or more DL signaling(s) or (starting) utilization of the resource allocation 1/2. The intermediate node may transmit a report (e.g., the left Report shown in the FIG. 10) for indicating a need of (keeping) the resource allocation 1/2. The intermediate node may transmit a report (e.g., the right Report shown in the FIG. 10) for indicating no need of (keeping) the resource allocation 1/2. Preferably in certain embodiments, the intermediate node may terminate the utilization of the resource allocation 1/2 for ambient IoT-related operation after the intermediate node indicates no need of (keeping) the resource allocation 1/2 or after the intermediate node receives the another one or more downlink control information for deactivating/releasing the resource allocation 1/2.

### Concept B

The concept B is that for requesting resources and/or assisting a network node in scheduling resources, the intermediate node may transmit/provide/report one or more information to a network node. Preferably in certain embodiments, when or in response that the network node receiving the one or more information, the network node may allocate/schedule/assign/provide/indicate a set of resources, via one or more DL signaling(s), for/to the intermediate node.

Preferably in certain embodiments, the set of resources may be utilized for ambient IoT-related operation (e.g., as described in Concept A). Preferably in certain embodiments, the set of resources may be utilized for an R2D transmission and/or a D2R transmission and/or a carrier wave transmission. Preferably in certain embodiments, the R2D transmission means a transmission from the intermediate node/reader to (ambient IoT) UE(s)/device(s). Preferably in certain embodiments, the D2R transmission means a transmission from (ambient IoT) UE(s)/device(s) to the intermediate node/reader. Preferably in certain embodiments, the carrier wave transmission may be transmitted from the intermediate node for the (ambient IoT) UE(s)'s/device(s)'s backscattered D2R transmission.

Preferably in certain embodiments, the one or more information may be related to ambient IoT-related operation and/or (ambient IoT) UE(s)/device(s). Preferably in certain embodiments, the one or more information may be an (assistance) information, e.g., related to the UE(s), device(s) and/or intermediate node(s). Preferably in certain embodiments, the one or more information may comprise any of the following (headings):

### Number/Amount of (Ambient IoT) UEs/Devices to be Served/Accessed/Communicated

Preferably in certain embodiments, the intermediate node may estimate/expect/derive/determine a number/amount of (ambient IoT) UEs/devices to be served/accessed/communicated. Preferably in certain embodiments, the intermediate node may estimate/expect/derive/determine a number/amount of UEs/devices for ambient IoT-related operation. Preferably in certain embodiments, the intermediate node may transmit/provide/report information of the number/amount of (ambient IoT) UEs/devices to the network node. Preferably in certain embodiments, the number/amount of (ambient IoT) UEs/devices may be determined/derived/indicated from a higher layer, e.g., application layer of/for ambient IoT.

Preferably in certain embodiments, the number/amount of UEs/devices may be quantified or classified into some number/value ranges of the number/amount of UEs/devices. Each number/value range may be associated/mapped to an index. Preferably in certain embodiments, there may be a mapping/table/association between index and a number/value range of the number/amount of UEs/devices. Preferably in certain embodiments, the intermediate node may derive/determine one index based on the number/amount of UEs/devices and the mapping/table/association. Preferably in certain embodiments, the intermediate node may transmit/provide/report the derived/determined one index to the network node. Preferably in certain embodiments, the mapping/table/association may be specified, fixed, (pre-)configured, provided/indicated by the intermediate node, or provided/indicated by the network node.

Preferably in certain embodiments, there may be some specific numbers/values of UEs/devices. The intermediate node may derive/determine one specific number/value based on the number/amount of UEs/devices, e.g., round up or round down the number/amount of UEs/devices based on the specific numbers/values. Preferably in certain embodiments, the intermediate node may transmit/provide/report the derived/determined one specific number/value to the network node. Preferably in certain embodiments, the (some) specific numbers/values may be specified, fixed, (pre-)configured, provided/indicated by the intermediate node, or provided/indicated by the network node.

### Coverage/Region to be Served/Accessed/Communicated

Preferably in certain embodiments, the intermediate node may estimate/expect/derive/determine a coverage/region for serving/accessing/communicating (ambient IoT) UE(s)/device(s) inside. Preferably in certain embodiments, the intermediate node may estimate/expect/derive/determine a coverage/region for performing ambient IoT-related operation. For the ambient IoT-related operation, target (ambient IoT) UE(s)/device(s) are within the coverage/region, e.g., centered from the intermediate node. Preferably in certain embodiments, the intermediate node may transmit/provide/report information of the coverage/region to the network node.

Preferably in certain embodiments, the coverage/region may be within or in the range of 10m to 50m. Preferably in certain embodiments, the coverage/region may be up to 50m. Preferably in certain embodiments, the coverage/region may be determined/derived/indicated from a higher layer, e.g., application layer of/for ambient IoT. Preferably in certain embodiments, the coverage/region may be or comprise a radius and/or a reference location (of the center of the coverage/region). Preferably in certain embodiments, the coverage/region may be or comprise one or more cells, tracking areas, or a range of area scope. Preferably in certain embodiments, the coverage/region may be quantified or classified into some number/value ranges of a coverage/region. Each coverage/region range may be associated/mapped to an index. Preferably in certain embodiments, there may be a mapping/table/association between index and number/value range of the coverage/region. Preferably in certain embodiments, the intermediate node may derive/determine one index based on the coverage/region and the mapping/table/association. Preferably in certain embodiments, the intermediate node may transmit/provide/report the derived/determined one index to the network node. Preferably in certain embodiments, the mapping/table/association may be specified, fixed, (pre-)configured, provided/indicated by the intermediate node, or provided/indicated by the network node.

Preferably in certain embodiments, there may be some specific numbers/values of a coverage/region. The intermediate node may derive/determine one specific number/value based on the coverage/region, e.g., round up or round down the coverage/region based on the specific numbers/values. Preferably in certain embodiments, the intermediate node may transmit/provide/report the derived/determined one specific number/value to the network node. Preferably in certain embodiments, the some specific numbers/values may be specified, fixed, (pre-)configured, provided/indicated by the intermediate node, or provided/indicated by the network node.

### UE (Geographic) Location

Preferably in certain embodiments, the intermediate node may provide its (geographic) location to the network node. The network node may select the intermediate node based on their location. The network node may determine the resource configuration based on the location of the intermediate node.

Preferably in certain embodiments, the intermediate node may update its location when/if (at least)/in response to that the intermediate node moves, e.g., in (or out) of a specific region, beyond a specific distance, leaving the current serving cell.

### Type of (Ambient IoT) UEs/Devices to be Served/Accessed/Communicated

Preferably in certain embodiments, the intermediate node may derive/determine one (or more) types of UEs/devices for performing ambient IoT-related operation. For the ambient IoT-related operation, target (ambient IoT) UE(s)/device(s) are associated with the one (or more) types of UEs/devices. Preferably in certain embodiments, the intermediate node may transmit/provide/report information of the one (or more) types of UEs/devices to the network node. Preferably in certain embodiments, the one (or more) types of UEs/devices may be determined/derived/indicated from a higher layer, e.g., application layer of/for ambient IoT.

Preferably in certain embodiments, the one (or more) types of UEs/devices may be/comprise one or a combination of a UE/device 1, a UE/device 2a, and/or a UE/device 2b. Preferably in certain embodiments, the one (or more) types of UEs/devices may comprise a UE/device with lower power consumption (e.g., ˜1 μW peak power consumption) and/or a UE/device with higher power consumption (e.g., a few hundred u W peak power consumption). Preferably in certain embodiments, the one (or more) types of devices may comprise a UE/device with a backscattered transmission and/or UE/device with an internally generated transmission.

Preferably in certain embodiments, the intermediate node may estimate/expect/derive/determine a number/amount of (ambient IoT) UEs/devices to be served/accessed/communicated for each type of (ambient IoT) UE(s)/device(s). Preferably in certain embodiments, the intermediate node may estimate/expect/derive/determine a number/amount of UEs/devices for each type of UEs/devices for ambient IoT-related operation. Preferably in certain embodiments, the intermediate node may transmit/provide/report information of the number/amount of (ambient IoT) UEs/devices for each type of UEs/devices to the network node. Preferably in certain embodiments, the number/amount of (ambient IoT) UEs/devices for each UEs/devices may be determined/derived/indicated from a higher layer, e.g., application layer of/for ambient IoT.

### Type of Service to Provide

Preferably in certain embodiments, the intermediate node may indicate a type of service (e.g., ambient IoT-related services) that the intermediate node is to provide/perform. Preferably in certain embodiments, the intermediate node may indicate multiple types of services that the intermediate node is to provide. The type of service may be (or comprise) (indoor) command or (indoor) inventory.

### Need of Carrier Wave (CW) Transmission Resource

Preferably in certain embodiments, the intermediate node may derive/determine whether the intermediate node will perform a carrier wave transmission for performing ambient IoT-related operation. Preferably in certain embodiments, the intermediate node may derive/determine whether to need resources for performing carrier wave transmission for ambient IoT-related operation. Preferably in certain embodiments, the intermediate node may transmit/provide/report information of a need of carrier wave transmission or carrier wave transmission resources to the network node. Preferably in certain embodiments, the intermediate node may transmit/provide/report information of whether a carrier wave is an inside or outside topology to the network node. Preferably in certain embodiments, the intermediate node may transmit/provide/report information of one or more scenarios to the network node, wherein the one or more scenarios may comprise any of D2T2-A1, D2T2-A2, D2T2-B, and/or D2T2-C (e.g., [5] RAN1 Chair's Notes for 3GPP TSG RAN WG1 #116bis). Preferably in certain embodiments, the need of a carrier wave transmission or a carrier wave transmission or the one or more scenarios may be determined/derived/indicated from a higher layer, e.g., application layer of/for ambient IoT.

### Type of Procedure(s) to be Performed

Preferably in certain embodiments, the intermediate node may derive/determine to perform one or more types of (ambient IoT-related) procedures/operations. Preferably in certain embodiments, the intermediate node may transmit/provide/report information of the one or more types of (ambient IoT-related) procedures/operations to the network node. Preferably in certain embodiments, the one or more types of (ambient IoT-related) procedures/operations may comprise any of an access procedure, contention-based access procedure, contention-free access procedure, Device-Originated-Device-Terminated Triggered (DO-DTT)/Device-Terminated (DT)/Device-Originated (DO)/Device-Originated-Autonomous (DO-A) procedure/operation, inventory procedure/operation, command procedure/operation, and/or communication procedure/operation. Preferably in certain embodiments, the one or more types of (ambient IoT-related) procedures/operations may be determined/derived/indicated from higher layer, e.g., application layer of/for ambient IoT.

### Type of Requested Resources

Preferably in certain embodiments, the intermediate node may indicate a type of requested resources that the intermediate node intends or prefers to request, is capable to use, or is supported. Preferably in certain embodiments, the intermediate node may indicate multiple types of requested resources that the intermediate node intends or prefers to request, is capable to use, or is supported. The type of requested resources may be (or comprise) in-band to NR, in guard-band to LTE/NR, or in standalone band(s). The type of requested resources may be (or comprise) time resources and/or frequency resources.

### Number/Amount of Requested Resources

Preferably in certain embodiments, the intermediate node may estimate/expect/derive/determine a number/amount of requested resources for ambient IoT-related operation. Preferably in certain embodiments, the intermediate node may transmit/provide/report information of the requested resources to the network node. Preferably in certain embodiments, the requested resources may be determined/derived/indicated from a higher layer, e.g., application layer of/for ambient IoT. Information of the requested resources for D2R and information of the requested resources for R2D may be indicated separately. Preferably in certain embodiments, the information of requested resources may comprise a number of PRBs per transmission band or per occupied band (for R2D and/or D2R).

Preferably in certain embodiments, the number/amount of requested resources may be in a unit of PRB, subcarriers, sub-channels, and/or frequency (sub-)band in frequency domain. Preferably in certain embodiments, the number/amount of requested resources may be in a unit of transmission/occupied bandwidths (for R2D and/or D2R transmission) in frequency domain. Preferably in certain embodiments, the number/amount of requested resources may comprise a required number/amount of frequency resources in frequency domain, e.g., required number/amount of PRB, subcarriers, sub-channels, and/or frequency (sub-)band. Preferably in certain embodiments, the number/amount of requested resources may comprise a required number/amount of transmission/occupied bandwidths (for R2D and/or D2R transmission) in frequency domain.

Preferably in certain embodiments, the number/amount of requested resources may be in a unit of symbols, set of symbols, sub-slots, slots, subframes, and/or milliseconds in time domain. Preferably in certain embodiments, the number/amount of requested resources may comprise a required number/amount of TTIs in time domain, e.g., required number/amount of symbols, set of symbols, sub-slots, slots, subframes, and/or milliseconds.

Preferably in certain embodiments, the number/amount of requested resources may be quantified or classified into some number/value ranges of the requested resources. Each number/value range may be associated/mapped to an index. Preferably in certain embodiments, there may be a mapping/table/association between index and number/value range of the number/amount of requested resources. Preferably in certain embodiments, the intermediate node may derive/determine one index based on the number/amount of requested resources and the mapping/table/association. Preferably in certain embodiments, the intermediate node may transmit/provide/report the derived/determined one index to the network node. Preferably in certain embodiments, the mapping/table/association may be specified, fixed, (pre-)configured, provided/indicated by the intermediate node, or provided/indicated by the network node.

Preferably in certain embodiments, there may be some specific numbers/values of requested resources. The intermediate node may derive/determine one specific number/value based on the number/amount of requested resources, e.g., round up or round down the number/amount of requested resources based on the specific numbers/values. Preferably in certain embodiments, the intermediate node may transmit/provide/report the derived/determined one specific number/value to the network node. Preferably in certain embodiments, the some specific numbers/values may be specified, fixed, (pre-)configured, provided/indicated by the intermediate node, or provided/indicated by the network node.

Information of the requested resources may indicate periodicity of the request resources, e.g., if periodic resources are requested. Information of the requested resources may indicate Quality of Service (QOS), delay tolerant, priority, and/or emergency of the request resources.

When, Latency, and/or how Long to Utilize Requested Resources

Preferably in certain embodiments, the intermediate node may estimate/expect/derive/determine a time information for ambient IoT-related operation. Preferably in certain embodiments, the intermediate node may transmit/provide/report the time information to the network node. Preferably in certain embodiments, the time information may be determined/derived/indicated from a higher layer, e.g., application layer of/for ambient IoT.

Preferably in certain embodiments, the time information may be/comprise a (maximum or minimum) latency requirement for starting ambient IoT-related operation. Preferably in certain embodiments, the intermediate node may estimate/expect/derive/determine the (maximum or minimum) latency requirement for starting ambient IoT-related operation. Preferably in certain embodiments, the intermediate node may transmit/provide/report information of the (maximum or minimum) latency requirement for starting ambient IoT-related operation to the network node. Preferably in certain embodiments, the latency requirement for starting ambient IoT-related operation may be determined/derived/indicated from a higher layer, e.g., application layer of/for ambient IoT.

Preferably in certain embodiments, the time information may be/comprise a (maximum or minimum) latency requirement for completing/finishing/performing ambient IoT-related operation. Preferably in certain embodiments, the intermediate node may estimate/expect/derive/determine the (maximum or minimum) latency requirement for completing/finishing/performing ambient IoT-related operation. Preferably in certain embodiments, the intermediate node may transmit/provide/report information of the (maximum or minimum) latency requirement for completing/finishing/performing ambient IoT-related operation to the network node.

Preferably in certain embodiments, the latency requirement for completing/finishing/performing ambient IoT-related operation may be determined/derived/indicated from a higher layer, e.g., application layer of/for ambient IoT.

Preferably in certain embodiments, the time information may be/comprise a (required) time duration/occupancy for completing/finishing/performing ambient IoT-related operation. Preferably in certain embodiments, the intermediate node may estimate/expect/derive/determine the (required) time duration/occupancy for completing/finishing/performing ambient IoT-related operation. Preferably in certain embodiments, the intermediate node may transmit/provide/report information of the (required) time duration/occupancy to the network node. Preferably in certain embodiments, the (required) time duration/occupancy may be determined/derived/indicated from a higher layer, e.g., application layer of/for ambient IoT.

Preferably in certain embodiments, the time information may be/comprise a (finished/ending) timing, wherein after the finished/ending timing, no resource is needed/required for performing ambient IoT-related operation. Preferably in certain embodiments, the intermediate node may estimate/expect/derive/determine the (finished/ending) timing for completing/finishing/performing ambient IoT-related operation. Preferably in certain embodiments, the intermediate node may transmit/provide/report information of the (finished/ending) timing to the network node. Preferably in certain embodiments, the (finished/ending) timing may be determined/derived/indicated from a higher layer, e.g., application layer of/for ambient IoT.

Preferably in certain embodiments, the time information may be in a unit of symbols, set of symbols, sub-slots, slots, subframes, and/or milliseconds in time domain.

Preferably in certain embodiments, the time information may be quantified or classified into some number/value ranges of the time information. Each number/value range may be associated/mapped to an index. Preferably in certain embodiments, there may be a mapping/table/association between an index and number/value range of the time information. Preferably in certain embodiments, the intermediate node may derive/determine one index based on (the number/value ranges of) the time information and the mapping/table/association. Preferably in certain embodiments, the intermediate node may transmit/provide/report the derived/determined one index to the network node. Preferably in certain embodiments, the mapping/table/association may be specified, fixed, (pre-)configured, provided/indicated by the intermediate node, or provided/indicated by the network node.

Preferably in certain embodiments, there may some specific numbers/values of time information. The intermediate node may derive/determine one specific number/value based on the number/amount of time information, e.g., round up or round down the number/amount of the time information based on the specific numbers/values. Preferably in certain embodiments, the intermediate node may transmit/provide/report the derived/determined one specific number/value to the network node. Preferably in certain embodiments, the some specific numbers/values may be specified, fixed, (pre-)configured, provided/indicated by the intermediate node, or provided/indicated by the network node.

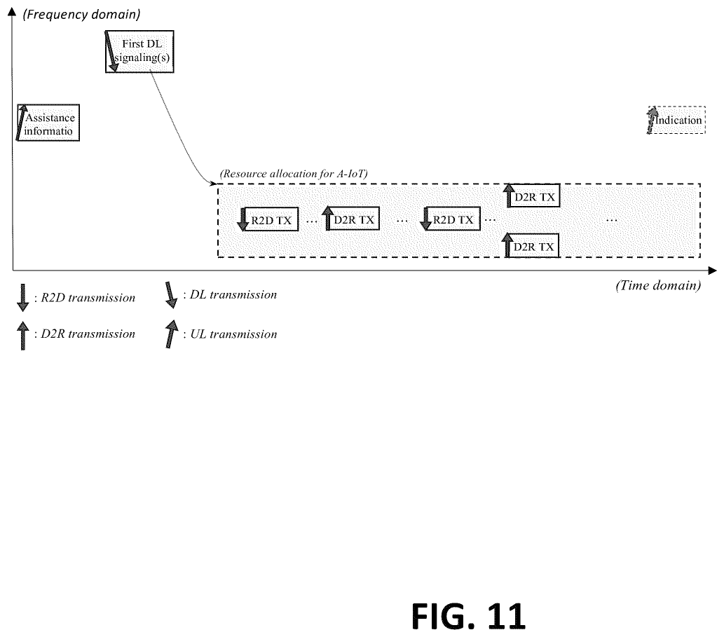

In one embodiment, as shown in FIG. 11, a UE (e.g., intermediate node) may transmit an assistance information to the Network (NW). The UE may receive a first DL signaling(s) which indicates the resource allocation for A-IoT. The UE may initiate A-IoT procedure(s) with device(s) (e.g., perform R2D transmission and/or D2R transmission). Preferably in certain embodiments, the UE may transmit an indication to the NW during or after the A-IoT procedure(s). The assistance information and/or the indication may be and/or comprise the one or more information. The assistance information may comprise at least any of: (expected) number of A-IoT devices to be inventoried/commanded, (expected) coverage to be inventoried, (geographic) location of the UE, type of A-IoT procedure/service to be performed (e.g., inventory and/or command), number/amount of requested resources for A-IoT, and/or latency to utilize requested resources. The indication may indicate at least any of: need of more resources, no need of utilizing resources and/or request for releasing resources. The resources may be A-IoT resources (e.g., used for R2D transmission and/or D2R transmission).

Preferably in certain embodiments, the intermediate node may transmit/provide/report the one or more information, to the network node, via transmitting one or more UL signaling(s). Preferably in certain embodiments, the one or more UL signaling(s) may be/comprise a Medium Access Control (MAC) Control Element (CE). Preferably in certain embodiments, the one or more UL signaling(s) may be/comprise a Physical Uplink Control Channel (PUCCH). Preferably in certain embodiments, the one or more UL signaling(s) may be/comprise an Uplink Control Information (UCI). Preferably in certain embodiments, the one or more UL signaling(s) may be/comprise a PUSCH. Preferably in certain embodiments, the one or more UL signaling(s) may be/comprise uplink data from a specific logical channel, e.g., associated with ambient IoT operations/services. Preferably in certain embodiments, the one or more UL signaling(s) may be/comprise an RRC message.

Preferably in certain embodiments, the intermediate node may transmit/provide/report first one or more information to the network node. After or in response to transmission of the first one or more information, the intermediate node may be prohibited from (re) transmitting the first one or more information for a specific time duration to the network node. Preferably in certain embodiments, the intermediate node may start a first timer (e.g., prohibit time for request). When the first timer is running, the intermediate node may be prohibited from (re) transmitting the first one or more information to the network node. When the first timer is not running, the intermediate node may (be allowed to) (re) transmit the first one or more information to the network node. Preferably in certain embodiments, the timer may be set based on the specific time duration. The specific time duration may be specified, fixed, and/or (pre-)configured. When the first timer expires, the intermediate node may (re) transmit the first one or more information to the network node. Preferably in certain embodiments, when the intermediate node (re) transmits the first one or more information, the intermediate node may update some of the first one or more information, i.e., update the time information as described above. When the intermediate node receives the one or more DL signaling(s) for allocating/scheduling/assigning/providing/indicating the set of resources, the intermediate node may stop the first timer (e.g., if the set of resources satisfies the first one or more information).

Preferably in certain embodiments, after transmission of the first one or more information, the intermediate node may generate second one or more information. Preferably in certain embodiments, the first one or more information and the second one or more information may be for different (ambient IoT) services/targets or with different requirements. Preferably in certain embodiments, (when the first timer is running) the intermediate node may (be allowed to) transmit/provide/report the second one or more information to the network node (if at least the first one or more information and the second one or more information are different). Preferably in certain embodiments, when the first timer is running, if the second one or more information is with a higher priority than the first one or more information, the intermediate node may transmit/provide/report the second one or more information to the network node. In this case, the intermediate node may suspend/pause/stop/terminate the (retransmissions of the) first one or more information to the network node. Alternatively, the intermediate node may resume/continue the (retransmissions of the) first one or more information to the network node. Preferably in certain embodiments, when the first timer is running, if the second one or more information is with a lower priority than the first one or more information, the intermediate node may be prohibited from transmitting/providing/reporting the second one or more information to the network node.

### Concept C

The concept C is that intermediate node and network node may need to coordinate/negotiate ambient IoT-related capability beforehand.

Preferably in certain embodiments, a network node may indicate whether the network node or a cell (i.e., operated by the network node) supports intermediate node functionality/functionalities for ambient IoT-related operation. Preferably in certain embodiments, the network node may indicate the support that the intermediate node performs R2D transmission and/or D2R reception being in-band of a cell or in a guard band. Preferably in certain embodiments, if the network node supports intermediate node functionality/functionalities, the network node may provide/broadcast common configuration(s) of intermediate node functionality/functionalities. Note that from the aspect of the network node or the cell, the support of intermediate node functionality/functionalities may mean/comprise the network node or the cell is capable/allowed to provide resources for one or more intermediate nodes to perform ambient IoT-related operation. From aspect of the network node or the cell, the support of intermediate node functionality/functionalities may mean/comprise the network node or the cell is capable/allowed to set/configure one or more UEs/devices (e.g., if the one or more UEs/device supports intermediate node functionality/functionalities) to be intermediate nodes for ambient IoT-related operation.

Preferably in certain embodiments, a network node may indicate whether the network node or a cell (i.e., operated by the network node) is operating/supporting ambient IoT with intermediate mode. Preferably in certain embodiments, the network node may indicate an operation mode for ambient IoT. The operation mode may indicate whether an ambient IoT operation involves (at least) an intermediate node. Preferably in certain embodiments, the network node may indicate whether the network node or a cell (i.e., operated by the network node) is operating/supporting ambient IoT.

Preferably in certain embodiments, a network node may transmit a request to a UE for being an intermediate node for ambient IoT operation. Preferably in certain embodiments, the network may transmit the request after receiving an indication of supporting intermediate node functionality/functionalities for ambient IoT operation from the UE. Preferably in certain embodiments, the request may indicate a request of being an intermediate node for ambient IoT transmission, ambient IoT reception, and/or both. Preferably in certain embodiments, in response to the request, the UE may transmit a response indicating that the request of being an intermediate node is accepted (or rejected). Preferably in certain embodiments, in response to the response (e.g., indicating that the UE is accepted), the network node may provide a configuration of intermediate node functionality/functionalities to the UE.

Preferably in certain embodiments, a UE/device may access, camp on, or (re) select the cell and/or the network node (based on whether the network node or the cell supports intermediate node functionality/functionalities for ambient IoT-related operation). Preferably in certain embodiments, the UE/device may acquire/obtain whether the network node or the cell supports intermediate node functionality/functionalities for ambient IoT-related operation. Preferably in certain embodiments, the UE/device may indicate whether the UE/device supports intermediate node functionality/functionalities for ambient IoT-related operation. Preferably in certain embodiments, if the UE/device does not support intermediate node functionality/functionalities, the UE/device may not indicate/report its capability about intermediate node functionality/functionalities. Preferably in certain embodiments, if the UE/device supports intermediate node functionality/functionalities, the UE/device may indicate/report its capability of supporting intermediate node functionality/functionalities. Preferably in certain embodiments, if the UE/device receives the common configuration(s) of intermediate node functionality/functionalities and if the UE/device supports intermediate node functionality/functionalities, the UE/device may indicate/report its capability of supporting intermediate node functionality/functionalities. Preferably in certain embodiments, if the network node or the cell receives the indication/report, the network node may provide/transmit (common and/or dedicated) configuration(s) of intermediate node functionality/functionalities to at least the UE/device. Preferably in certain embodiments, if the UE/device supports intermediate node functionality/functionalities, the UE/device may request (some/further) configuration(s) of intermediate node functionality/functionalities. Preferably in certain embodiments, if the UE/device supports intermediate node functionality/functionalities, the UE/device may request to be an intermediate node for ambient IoT operation. Preferably in certain embodiments, if the network node or the cell receives the request, the network node may provide/transmit (common and/or dedicated) configuration(s) of intermediate node functionality/functionalities to at least the UE/device. Note that from aspect of the UE/device, the support of intermediate node functionality/functionalities may mean/comprise the UE/device is capable/allowed to perform ambient IoT-related operation as an intermediate node. From the aspect of the UE/device, the support of intermediate node functionality/functionalities may mean/comprise the UE/device is capable/allowed to utilize and/or request the set of resources for ambient IoT-related operation, e.g., as described in concept A and/or B (e.g., if the network node or the cell supports intermediate node functionality/functionalities).

Preferably in certain embodiments, the (common and/or dedicated) configuration(s) of intermediate node functionality/functionalities may comprise any one or more configuration(s) as described in concept A and/or B.

Preferably in certain embodiments, the UE/device may (start to) act/operate as an intermediate node (e.g., utilize and/or request the set of resources for ambient IoT-related operation, e.g., as described in concept A and/or B), after or in response that the UE/device receives the (common and/or dedicated) configuration(s) of intermediate node functionality/functionalities. Preferably in certain embodiments, the UE/device may (start to) act/operate as an intermediate node (e.g., utilize and/or request the set of resources for ambient IoT-related operation, e.g., as described in concept A and/or B), after or in response that the UE/device receives an activation/enabling signaling or command from the network node or the cell.

Preferably in certain embodiments, the UE/device may stop/terminate acting/operating as an intermediate node after or in response that the UE/device releases the (common and/or dedicated) configuration(s) of intermediate node functionality/functionalities. Preferably in certain embodiments, the UE/device may stop/terminate acting/operating as an intermediate node after or in response that the UE/device receives a deactivation/disabling signaling or command from the network node or the cell.

Preferably in certain embodiments, the UE/device supporting intermediate node functionality/functionalities may not be an ambient IoT UE/device. Preferably in certain embodiments, the UE/device supporting intermediate node functionality/functionalities may not be any of the Device 1, Device 2a, Device 2b.

Preferably in certain embodiments, the UE/device may perform the concept C before performing the concept A and/or B.

Various examples and embodiments of the present invention are described below. For the methods, alternatives, concepts, examples, and embodiments detailed above and herein, the following aspects and embodiments are possible.

Note that any of above concepts, methods, alternatives, instances and embodiments (e.g., in concept A, B and/or C) may be combined or applied simultaneously, in whole or in part.

Preferably in certain embodiments, the intermediate node may be/comprise a transmitter of an intermediate node. Preferably in certain embodiments, the intermediate node may be/comprise a transmitter of R2D transmissions. Preferably in certain embodiments, the intermediate node may be/comprise a transmitter of Carrier Wave (CW) transmissions. Preferably in certain embodiments, the intermediate node may utilize the set of resources for transmitting R2D transmissions and not utilize the set of resources for receiving D2R transmissions, e.g., the “R1” in the scenario D2T2-A1.

Preferably in certain embodiments, the intermediate node may be/comprise a receiver of an intermediate node. Preferably in certain embodiments, the intermediate node may be/comprise a receiver of

D2R transmissions. Preferably in certain embodiments, the intermediate node may utilize the set of resources for receiving D2R transmissions and not utilize the set of resources for transmitting R2D transmissions, e.g., the “R2” in the scenario D2T2-A1.

Preferably in certain embodiments, the intermediate node may be/comprise a transmitter and a receiver of an intermediate node. Preferably in certain embodiments, the intermediate node may be/comprise a transmitter of R2D transmissions and a receiver of D2R transmissions. Preferably in certain embodiments, the intermediate node may be/comprise a transmitter of CW transmissions. Preferably in certain embodiments, the intermediate node may utilize the set of resources for transmitting R2D transmissions and utilize the set of resources for receiving D2R transmissions, e.g., the “R” in the scenario D2T2-A2, D2T2-B, and/or D2T2-C.

Preferably in certain embodiments, the ambient IoT-related operation may be/comprise any of an access procedure, contention-based access procedure, contention-free access procedure, DO-DTT/DT/DO/DO-A procedure/operation, inventory procedure/operation, command procedure/operation, and/or communication procedure/operation (for ambient IoT UEs/devices).

Preferably in certain embodiments, the intermediate node may be/mean a relay, Integrated Access and Backhaul (IAB) node, repeater which is capable of Ambient IoT. Preferably in certain embodiments, the intermediate node be/mean a UE/device capable of Ambient IoT. Preferably in certain embodiments, the intermediate node may be/mean or replaced as an intermediate device. Preferably in certain embodiments, the intermediate node may access or connect to the network node.

Preferably in certain embodiments, the access procedure is utilized for (ambient IoT) devices/UEs.

Preferably in certain embodiments, the (ambient IoT) device/UE may access or connect to the network/intermediate node via the access procedure. Preferably in certain embodiments, the (ambient IoT) device/UE may perform (data or control) transmission(s) and reception(s) with the network/intermediate node via the access procedure. The access procedure may comprise a (data or control) communication operation. Alternatively or preferable, the access procedure may not comprise a (data or control) communication operation. Preferably in certain embodiments, the (data or control) communication operation may be/comprise (at least) transmission(s) and/or reception(s) between the (ambient IoT) device/UE and the network/intermediate node. The (ambient IoT) device/UE may perform the (data or control) communication operation comprising (at least) receiving a valid (R2D) response associated with a first (D2R) signal/transmission, transmitting a (ambient IoT) device/UE information after receiving the valid (R2D) response, receiving a specific indication/signaling, transmitting D2R data/signal transmission(s) and/or receiving R2D data/signal transmission(s).

Preferably in certain embodiments, the access procedure may be/mean (or include) an inventory procedure. Preferably in certain embodiments, the access procedure may be performed for inventory.

Preferably in certain embodiments, the network/intermediate node may perform/support a procedure/communication/operation with non-ambient IoT devices/UEs in some frequency bandwidth, which are separated, with at least some frequency gap or guard band, from the set of resources for ambient IoT-related operations/procedures.

Preferably in certain embodiments, the R2D transmission bandwidth may be/mean (or include) frequency resources used to perform R2D transmissions/receptions. Preferably or alternatively in certain embodiments, the network/intermediate node may perform one Physical Reader (to Ambient IoT) Device Channel (PRDCH) (restricted to be) within one R2D transmission bandwidth. Preferably in certain embodiments, the network/intermediate node may not perform (or prevent from performing) one PRDCH across multiple R2D transmission bandwidths. Preferably in certain embodiments, an R2D transmission bandwidth may be/mean or be replaced by any of a (R2D) bandwidth part or a (R2D) sub-channel or a (R2D) frequency unit.

Preferably in certain embodiments, the D2R transmission bandwidth may be/mean (or include) frequency resources used for performing D2R transmissions/receptions. Preferably or alternatively in certain embodiments, the network/intermediate node may perform one Physical (Ambient IoT) Device (to) Reader Channel (PDRCH) (restricted to be) within one D2R transmission bandwidth. Preferably in certain embodiments, the network/intermediate node may not perform (or prevent from performing) one PDRCH across multiple D2R transmission bandwidths. Preferably in certain embodiments, a D2R transmission bandwidth may be/mean or be replaced by any of a (D2R) bandwidth part or a (D2R) sub-channel or a (D2R) frequency unit.

Preferably in certain embodiments, the D2R may be/mean or be replaced/changed/represented as from the device/UE to the reader/network/intermediate node. Preferably in certain embodiments, the D2R may be/mean or be replaced/changed/represented as uplink (UL).

Preferably in certain embodiments, the R2D may be/mean or be replaced/changed/represented as from the reader/network/intermediate node to the device/UE. Preferably in certain embodiments, the R2D may be/mean or be replaced/changed/represented as downlink (DL).

Preferably in certain embodiments, the R2D transmission may comprise/mean a PRDCH transmission. Preferably in certain embodiments, the R2D transmission may comprise/mean a PRDCH transmission and an R2D timing acquisition signal (e.g., R2D preamble, clock-acquisition part, and/or start-indicator part) associated with the PRDCH transmission, and/or postamble associated with the PRDCH transmission.

Preferably in certain embodiments, the D2R transmission may comprise/mean a PDRCH transmission. Preferably in certain embodiments, the D2R transmission may comprise/mean a PDRCH transmission and a D2R timing acquisition signal (e.g., D2R preamble) associated with the PDRCH transmission, midamble(s) associated with the PDRCH transmission, and/or postamble associated with the PDRCH transmission.

Preferably in certain embodiments, the PDRCH may be/mean or be replaced/changed/represented as a channel/transmission from the device/UE to the reader/network/intermediate node. Preferably in certain embodiments, the PDRCH may be replaced by “physical channel for D2R (data and/or control) transmission”.

Preferably in certain embodiments, the PRDCH may be/mean or be replaced/changed/represented as a channel/transmission from the reader/network/intermediate node to the device/UE. Preferably in certain embodiments, the PRDCH may be replaced by “physical channel for R2D (data and/or control) transmission”.

Preferably in certain embodiments, the occasion/timing/TTI may be/mean or be replaced/changed/represented as a slot. Preferably in certain embodiments, the occasion/timing/TTI may be/mean or be replaced/changed/represented as a subframe. Preferably in certain embodiments, the occasion/timing/TTI may be/mean or be replaced/changed/represented as a sub-slot or mini-slot. Preferably in certain embodiments, the occasion/timing/TTI may comprise a number (e.g., a predefined/fixed/(pre-)configured or indicated number) of symbols in time domain.

Preferably in certain embodiments, the occasion/timing/TTI may be/mean or be replaced/changed/represented as a transmission occasion. Preferably in certain embodiments, the occasion/timing/TTI may be/mean or be replaced/changed/represented as a reception occasion.

Preferably in certain embodiments, the carrier wave (signal) above may be changed/represented/replaced as a DL signal/R2D or a DL/R2D channel. Preferably in certain embodiments, the carrier wave (signal) may be changed/represented/replaced as any signal for a power source/supply (e.g., transmitted from network node or intermediate node).

Preferably in certain embodiments, the first/second device/UE may receive/detect the carrier wave (signal) in R2D frequency bandwidth. Preferably or alternatively in certain embodiments, the first/second device/UE may receive/detect the carrier wave (signal) in D2R frequency bandwidth.

Preferably in certain embodiments, the first/second device/UE may perform D2R transmission via backscatter on the carrier wave (signal), e.g., provided externally or via generated internally by the first/second device/UE.

Preferably in certain embodiments, the network/intermediate node may transmit an indication related to or about whether a (serving or camped on) cell (of the UE or the network/intermediate node) support more than one D2R frequency bandwidth or not. Preferably in certain embodiments, the UE may receive the indication related to or about whether the (serving or camped on) cell (of the UE or the network/intermediate node) support more than one D2R frequency bandwidth or not. Preferably in certain embodiments, the indication may be provided/transmitted/comprised in the paging/query information. Preferably in certain embodiments, the indication may be provided/transmitted/comprised in the specific indication/signaling. Alternatively or preferably in certain embodiments, the indication may be provided/transmitted/comprised in a configuration provided from the network/intermediate node. Alternatively or preferably in certain embodiments, the indication may be specified or (pre-)configured or fixed.

Throughout the present disclosure, the reader may be and/or be replaced by an NW, UE, interrogator, and/or intermediate node. Throughout the present disclosure, the device may be and/or be replaced by a UE, tag and/or intermediate node. The device may be referred to as an ambient IoT device. The “UE” may comprise a reader, tag, and/or device. The “NW/intermediate node” may comprise a reader and/or an interrogator.

The UE/device may receive carrier wave(s) from a reader. The UE/device may receive carrier wave(s) from a node other than the reader.

Throughout the present disclosure, the backscattering (BS) may be replaced by “Device to Reader (D2R)” or “UL”. The backscattering transmission may be, be referred to, and/or be supplemented by a transmission from a device to a reader and/or a D2R transmission, e.g., PDRCH.

The UE may be referred to as the UE, an RRC layer of the UE, a MAC entity of the UE, or a physical layer of the UE.

Throughout the present disclosure, the UE may be an NR device. The UE may not be a legacy UE. The legacy UE may be a non-ambient IoT device. The legacy UE may perform different procedures from the ambient IoT UE. The UE may be a legacy UE with capability to perform an ambient IoT procedure.

The network may be a network node. The network may be a base station. The network may be an access point. The network may be an Evolved Node B (eNB). The network may be a gNB. The network may be a gateway. The network may be an interrogator.

An Ambient IoT device may perform R2D reception from a first intermediate node operated as a first reader. That is, the first intermediate node may perform R2D transmission to the device. The device may perform D2R transmission to a second intermediate node operated as a second reader. That is, the device may perform D2R transmission to the second intermediate node. The (first and second) intermediate node may perform DL reception and/or UL transmission to the cell as the normal traffic of an NR UE (i.e., not an ambient IoT device) through Uu interface. From the device aspect, the device may or may not know/identity whether a reader performing R2D transmission and/or receiving D2R transmission is either a network node or an intermediate node.

The scheduling of D2R transmissions should be indicated via PRDCH. This means that the R2D intermediate node would include D2R (time/frequency) resources in its R2D signaling to the device. However, the D2R intermediate node also needs to understand where/when to receive the D2R transmission from the device. The D2R intermediate node may otherwise need to keep performing blind decoding. Additionally, for a monostatic reader case, after the device performs the D2R transmission, the R2D intermediate node should act differently based on whether the D2R transmission is successfully decoded or not. If the D2R transmission is successfully decoded, the R2D intermediate node could schedule a subsequent D2R transmission (if any). If the D2R transmission is unsuccessfully decoded, the R2D intermediate node could send an R2D message indicating the ambient IoT device to re-transmit/re-access. However, the R2D intermediate node would not acknowledge whether the D2R transmission from the device is successfully decoded by the D2R intermediate node or not. As a result, the R2D intermediate node and the D2R intermediate node need coordination from the network.

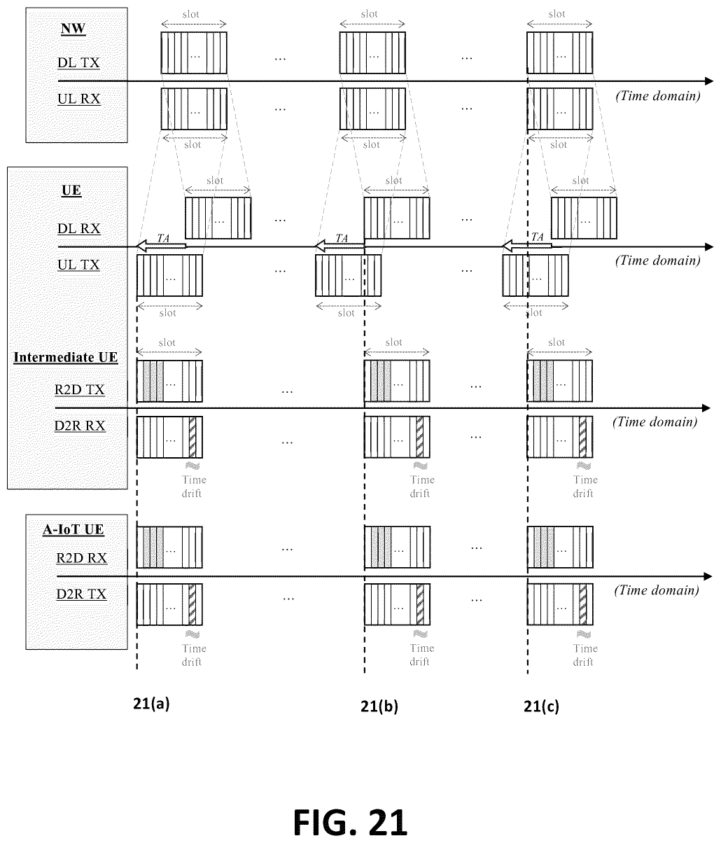

The first intermediate node may perform R2D transmission to the device after receiving one or more DL signaling(s) (e.g., DCI) from the reader (or the network). The timing/occasion (e.g., frame, subframe, symbol or slot) of R2D transmission from the first intermediate node to the device may be aligned with the timing/occasion of the UL transmission (of the first intermediate node). For example, the first intermediate node may perform R2D transmission in the (configured) UL time resource(s) (i.e., the same time resource(s) to perform a normal UL transmission). The first intermediate node may not perform R2D transmission outside the (configured) UL time resource(s). Preferably in certain embodiments, the first intermediate node may perform the R2D transmission based on or aligned with UL timing. Preferably in certain embodiments, the first intermediate node may perform the R2D transmission with reference to UL timing. Preferably in certain embodiments, the first intermediate node may perform the R2D transmission based on timing advance, wherein the timing advance is applied for uplink transmission (e.g., PUSCH, PUCCH, Sounding Reference Signal (SRS)). Preferably in certain embodiments, the start of the R2D transmission from the first intermediate node may (assumed to) be aligned with the boundary of an NR UL OFDM symbol (including the CP). Section 21(a) of FIG. 21 shows an instance of aligning R2D transmission with UL timing.

Alternatively, the timing/occasion (e.g., frame, subframe, symbol or slot) of the R2D transmission from the first intermediate node to the device may be aligned with the timing/occasion of the DL transmission. The first intermediate node may derive/determine the timing of the DL transmission based on at least the timing advance. Preferably in certain embodiments, the first intermediate node may derive/determine the timing of the DL transmission based on a configured/indicate time offset and a half of the timing advance. Section 21(c) of FIG. 21 shows an instance of aligning the R2D transmission with the derived/determined DL transmission timing. Alternatively, the timing (e.g., frame, subframe, symbol or slot) of R2D transmission from the first intermediate node to the device may be aligned with the timing of the DL reception (of the first intermediate node). Section 21(b) of FIG. 21 shows an instance of aligning the R2D transmission with the DL reception timing. For example, the first intermediate node may perform the R2D transmission in the (configured) DL time resource(s) (i.e. the same time resource to perform a normal DL reception). The first intermediate node may not perform the R2D transmission outside the (configured) DL time resource(s).

For example, the (UL/DL) time resource(s) may be located in consecutive TTIs. Preferably in certain embodiments, the one or more DL signaling(s) may indicate a starting timing, an ending timing and/or a number of consecutive TTIs of the (UL/DL) time resource(s). Preferably in certain embodiments, the one or more DL signaling(s) may indicate a first time offset for deriving/determining the starting timing. Preferably in certain embodiments, the one or more DL signaling(s) may indicate a first time duration for deriving/determining the number of consecutive TTIs or a number of the (UL/DL) time resource(s). Preferably in certain embodiments, the number of the (UL/DL) time resource(s) is the same as the number of consecutive TTIs.

For another example, the (UL/DL) time resource(s) may be located in separate TTIs as allocated/scheduled/assigned/provided/indicated by the one or more DL signaling(s), e.g., no limitation of consecution in time domain. Preferably in certain embodiments, the one or more DL signaling(s) may indicate each TTI of the (UL/DL) time resources. Preferably in certain embodiments, the one or more DL signaling(s) may indicate a first/initial TTI for a first/initial resource among the (UL/DL) time resources. Preferably in certain embodiments, the one or more DL signaling(s) may indicate a second time offset, between a second TTI and the first/initial TTI, for a second resource among the (UL/DL) time resources. Preferably in certain embodiments, the one or more DL signaling(s) may indicate a third time offset, between a third TTI and the first/initial TTI or between the third TTI and the second TTI, for a third resource among the (UL/DL) time resources. Preferably in certain embodiments, the (UL/DL) time resources may be restricted within a second time duration. The second time duration may be counted/derived/calculated starting from the first/initial TTI.

In (at least) the case that the first and the second intermediate nodes are different (intermediate) UEs, the two intermediate nodes may communicate with each other to exchange a first information for the Ambient IoT device(s). Alternatively or additionally in certain embodiments, the coordination of the first and the second intermediate node may be handled by the network, with a second information provided/exchanged between the intermediate node(s) and the network.

The (first, second) information may be (or comprise) the serving device ID(s) and/or device group ID(s). A device may be assigned a device ID. The device may be predefined or (pre-)configured (e.g., by the device) with the device ID. The device may be configured or indicated (e.g., by the NW) with the device ID. The device may calculate, select, derive, or determine the device ID by itself. Additionally, there may be multiple device groups. A device may be assigned or associated with a device group. The device may be predefined or (pre-)configured (e.g., by the device) with the device group. The device may be configured or indicated (e.g., by the NW) with the device group. The device may receive a group ID and/or a value to derive/determine the group ID via paging, System Information Block (SIB), and/or PRDCH. The device may receive a group ID and/or a value to derive/determine the group ID during registration or authentication. The device may derive or determine the group ID based on the device ID. The device ID(s) or the device group ID(s) may be temporary ID(s).

For example, a first intermediate node may send a first information to a second intermediate node with one or multiple device(s) being served by the first intermediate node. The second intermediate node may send a confirmation (or acknowledgment) to the first intermediate node, if (at least) one (or some of, or all of) the device(s) included in the first information is also served by the second intermediate node. Alternatively in certain embodiments, the second intermediate node may not (need to) send the confirmation (or acknowledgment) to the first intermediate node, if (at least) one (or some of, or all of) device(s) included in the first information is also served by the second intermediate node. The second intermediate node may send a negative confirmation (or acknowledgment) to the first intermediate node), if (at least) none of the device(s) included in the first information is served by the second intermediate node.

The (first, second) information may be (or comprise) the pairing of the intermediate nodes. For example, a first intermediate node may be (or may be required to be) paired with a second intermediate node to serve the same (group of) devices. A (group of) device(s) receiving the R2D transmission from the first intermediate node may perform the D2R transmission to the second intermediate node. The (group of) device(s) receiving the R2D transmission from the first intermediate node (in the same device group) may not perform the D2R transmission to a third intermediate node, if (at least) the third intermediate node is not the second intermediate node. The (group of) device(s) performing the D2R transmission to the second intermediate node may perform R2D reception from the first intermediate node. The (group of) device(s) performing the D2R transmission to the second intermediate node may not perform R2D reception from a fourth intermediate node, if (at least) the fourth intermediate node is not the first intermediate node. The first intermediate node may send a first information with an indicator of pairing to the second intermediate node.

Alternatively or additionally in certain embodiments, the second intermediate node may send the first information with an indicator of pairing to the first intermediate node. For example, a first intermediate node may transmit a request to a second intermediate node for pairing. In response, the second intermediate node may transmit a response to the first intermediate node. The response may indicate that the request is accepted (or rejected). Alternatively or additionally in certain embodiments, the network may send a second information to the first intermediate node with the information (e.g., UE ID) of the second intermediate node. Alternatively or additionally in certain embodiments, the network may send the second information to the second intermediate node with the information (e.g., UE ID) of the first intermediate node.

The (first, second) information may be (or comprise) a reader ID for identifying the reader for performing R2D transmission and/or D2R transmission. The (first, second) information may be a reader ID utilized by the first intermediate node and the second intermediate node. The first intermediate node may perform an R2D transmission with information of the reader ID. The first device may perform a D2R transmission in response to the R2D transmission or control information in the R2D transmission. The D2R transmission may or may not include the information of the reader ID. Preferably in certain embodiments, the second intermediate node may monitor the R2D transmission. When the second intermediate node receives/detects an R2D transmission with information of the reader ID, the second intermediate node may (start to) monitor/detect/receive the corresponding D2R transmission (in response to the R2D transmission or control information in the R2D transmission). When the second intermediate node receives/detects another R2D transmission with information of another reader ID, the second intermediate node does not monitor/detect/receive the D2R transmission in response to the another R2D transmission or another control information in the another R2D transmission. Alternatively or preferably in certain embodiments, the second intermediate node may not monitor an R2D transmission. When the second intermediate node receives/detects a D2R transmission with information of the reader ID, the second intermediate node may decode/store the D2R transmission. When the second intermediate node receives/detects a D2R transmission with information of another reader ID, the second intermediate node does not decode/store the D2R transmission.

Alternatively in certain embodiments, the (first, second) information may be (or comprise) a first reader ID for identifying the reader for performing an R2D transmission and a second reader ID for identifying the reader for performing a D2R transmission. The (first, second) information may be a reader ID utilized by the first intermediate node and the second intermediate node. The first intermediate node may perform an R2D transmission with information of the first reader ID. The first device may perform a D2R transmission in response to the R2D transmission or control information in the R2D transmission. The D2R transmission may or may not include the information of the first reader ID. The D2R transmission may or may not include the information of the second reader ID (for instance, the control information in the R2D transmission may indicate the second reader ID). Preferably in certain embodiments, the second intermediate node may monitor an R2D transmission. When the second intermediate node receives/detects a R2D transmission with information of the first reader ID, the second intermediate node may (start to) monitor/detect/receive a corresponding D2R transmission (in response to the R2D transmission or control information in the R2D transmission). When the second intermediate node receives/detects another R2D transmission with information of another reader ID, the second intermediate node does not monitor/detect/receive D2R transmission in response to the another R2D transmission or another control information in the another R2D transmission. Alternatively and/or preferably in certain embodiments, the second intermediate node may not monitor an R2D transmission. When the second intermediate node receives/detects a D2R transmission with information of the second reader ID (and/or information of the first reader ID), the second intermediate node may decode/store the D2R transmission. When the second intermediate node receives/detects a D2R transmission with information of another reader ID, the second intermediate node does not decode/store the D2R transmission.

The (first, second) information may be (or comprise) time information for D2R transmission. The device may perform a D2R transmission to the second intermediate node after being triggered by the reader (e.g., R2D signal). The timing/occasion (e.g., frame, subframe, symbol or slot) of the D2R transmission from the device to the second intermediate node may be determined/decided by a time information. The time information may be provided by a signaling from the first intermediate node. The device may perform the D2R transmission based on or in response to (receiving) the signaling. The signaling may be a query, a paging, an SIB, an RRC message (e.g., RRC setup request), a MAC signaling (e.g., MAC CE) and/or a Physical Layer (PHY) signaling (e.g., PRDCH, PDCCH, DCI). The signaling may be (or include) a common signaling. The signaling may be (or include) a broadcast signaling. The signaling may be received by multiple

UEs (or a group of UEs), e.g., in a UE group. The signaling may be (or include) a dedicated signaling. The signaling may be (or include) a UE-specific signaling.

The time information may be, comprise, be replaced by, be referred to, be represented by, and/or be indicated by a time duration, a timer (value), and/or an indication (e.g., of duration level). The time information may be a (minimum) required time (e.g., of energy or power accumulation) for the D2R transmission. In other words, the UE may not (expect to) perform the D2R transmission before the end of the time indicated by this information.

Alternatively or additionally in certain embodiments, the time information may indicate a suggested (or expected/preferred) time (duration) or expiry/expiration time for the D2R transmission. Before the start of the time, the UE may not (expect to) perform the D2R transmission. After the end of the time or after the expiry time, the UE may not (expect to) perform the D2R transmission.

The time information may indicate a starting point (e.g., TTI) of the time. The time information may indicate a length (e.g., TTI) of the time. The time information may indicate an ending point (e.g., TTI) of the time. The time information may be represented by ms, frame, subframe, symbol, and/or slot. The time information may be based on the timing of a (serving) cell of the second intermediate node. The time information may be based on the timing of a (serving) cell of the first intermediate node. The time information may be based on the timing of a (serving) cell of the device.

The timing/occasion (e.g., frame, subframe, symbol, or slot) of D2R reception in the second intermediate node may be aligned with the timing/occasion of the UL transmission (of the first intermediate node). For example, the second intermediate node may perform D2R reception in the (configured) UL time resource(s) (i.e. the same time resource(s) to perform a normal UL transmission). The second intermediate node may not perform the D2R reception outside the (configured) UL time resource(s). Preferably in certain embodiments, the second intermediate node may perform the D2R reception based on or aligned with UL timing. Preferably in certain embodiments, the second intermediate node may perform the D2R reception with reference to UL timing. Preferably in certain embodiments, the second intermediate node may perform the

D2R reception based on timing advance, wherein the timing advance is applied for uplink transmission (e.g., PUSCH, PUCCH, SRS). Preferably in certain embodiments, the start of the D2R reception in the second intermediate node may (be assumed to) be aligned with the boundary of an NR UL OFDM symbol (including the CP).

Alternatively in certain embodiments, the timing/occasion (e.g., frame, subframe, symbol, or slot) of D2R reception in the second intermediate node may be aligned with the timing/occasion of the DL transmission. The second intermediate node may derive/determine the timing of the DL transmission based on at least the timing advance. Preferably in certain embodiments, the second intermediate node may derive/determine the timing of the DL transmission based on a configured/indicated time offset and a half of the timing advance. Alternatively in certain embodiments, the timing/occasion (e.g., frame, subframe, symbol or slot) of D2R reception in the second intermediate node may be aligned with the timing/occasion of the DL reception (of the second intermediate node). The second intermediate node may perform the D2R reception in the (configured) DL time resource(s) (i.e. the same time resource to perform the normal DL reception). The second intermediate node may not perform the D2R reception outside the (configured) DL time resource(s).

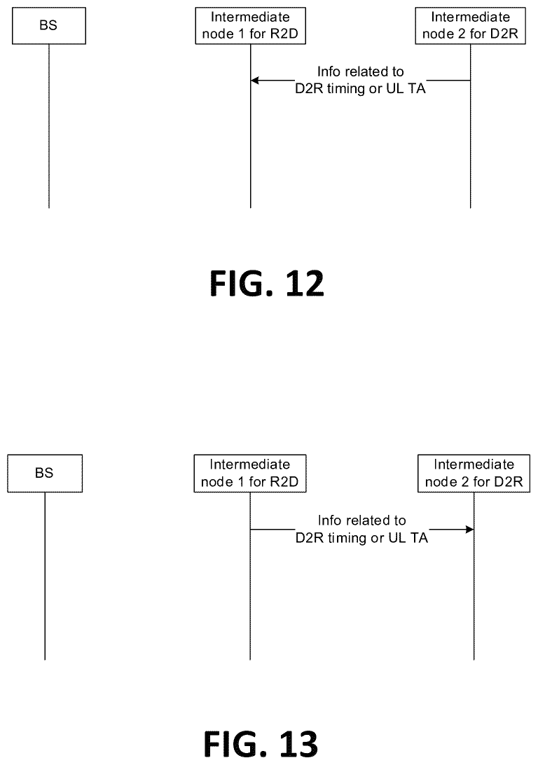

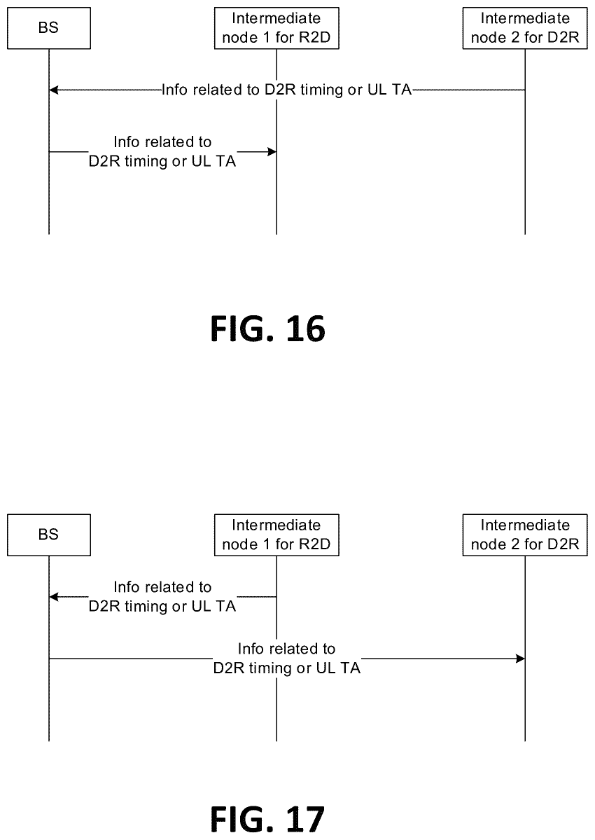

For example, as shown in FIG. 12, a second intermediate node (of a first device) may send a first information including a time information to a first intermediate node (of the first device). The time information may be timing for D2R transmission and/or UL timing advance (of the second intermediate node). The first intermediate node may indicate the D2R transmission timing (included in the first information) to the (first) device via R2D transmission. The device may perform D2R transmission based on the received D2R transmission timing. For another example, as shown in FIG. 13, a first intermediate node (of a first device) may send a first information including a time information to a second intermediate node (of the first device). The time information may be timing for D2R transmission and/or UL timing advance (of the second intermediate node). The second intermediate may perform D2R reception based on the time information included/indicated in the first information. The second intermediate may not perform D2R reception outside the time included/indicated in the first information. For example, as shown in FIG. 16, a second intermediate node (of a first device) may provide a timing information to the network (e.g., with UE assistance information). The timing information may be related to timing of D2R reception and/or UL timing advance. The network may send a second information to a first intermediate node (of the first device) including the time information and/or derived D2R transmission timing. The first intermediate node may indicate the timing for D2R transmission to the (first) device via R2D transmission. The (first) device may perform D2R transmission based on the received D2R timing. For another example, as shown in FIG. 17, a first intermediate node (of a first device) may provide a timing information to the network (e.g., with UE assistance information). The timing information may be related to timing of D2R reception and/or UL timing advance. The network may send a second information to a second intermediate node (of the first device) including the time information and/or derived D2R reception timing. The second intermediate node may perform D2R reception based on the D2R timing received in the second information. The second intermediate node may not perform D2R reception outside the time indicated in the second information.

The (first, second) information may be (or comprise) whether the (intermediate node) functionalities are started/stopped. The (intermediate node) functionalities may refer to the support of R2D and/or D2R transmission. The (intermediate node) functionalities may refer to Ambient IoT-related procedures/operations, including (and not limited to) an access procedure, contention-based access procedure, contention-free access procedure, DO-DTT/DT/DO/DO-A procedure/operation, command procedure/operation, inventory procedure/operation, and/or communication procedure/operation. The (intermediate node) functionalities may include (time/frequency) resource for R2D/D2R transmission. The support of intermediate node functionalities may mean/comprise the (intermediate) UE is capable/allowed to utilize and/or request the set of resources for ambient IoT-related operation.

A cell (or network node) may indicate whether to support intermediate node functionality/functionalities for ambient IoT-related operation. The cell may indicate the support that the intermediate node performs R2D transmission and/or D2R reception being in-band of cell or in guard band. If (at least) the network node supports intermediate node functionality/functionalities, the cell may provide/broadcast common configuration(s) of intermediate node functionality/functionalities. Note that from the aspect of the cell, the support of intermediate node functionality/functionalities may mean/comprise the cell is capable/allowed to provide resources for one or more intermediate nodes to perform ambient IoT-related operation. From the aspect of the cell, the support of intermediate node functionality/functionalities may mean/comprise the cell is capable/allowed to set/configure one or more (intermediate) UEs (e.g., if the one or more UEs support intermediate node functionality/functionalities) to be intermediate nodes for ambient IoT-related operation.

For example, a first intermediate node (of a first device) may send a first information to a second intermediate node (of the first device) when the (intermediate node) functionalities start/stop. The second intermediate node (of the first device) may consider the first intermediate node (of the first device) able to perform R2D transmission to the (first) device after receiving the first information of functionalities started.

The second intermediate node (of the first device) may consider the first intermediate node (of the first device) not able to perform R2D transmission to the (first) device after receiving the first information of functionalities stopped. For another example, a second intermediate node (of a first device) may send a first information to a first intermediate node (of the first device) when the (intermediate node) functionalities start/stop. The first intermediate node (of the first device) may consider the second intermediate node (of the first device) able to perform D2R transmission from the (first) device after receiving the first information of functionalities started. The first intermediate node (of the first device) may consider the second intermediate node (of the first device) not able to perform D2R transmission from the (first) device after receiving the first information of functionalities stopped. For example, the network may send a second information to a second intermediate node (of a first device) when the first intermediate node (of the first device) functionalities start/stop. The second intermediate node (of the first device) may consider the first intermediate node able to perform R2D transmission to the (first) device after receiving the second information of functionalities started. The second intermediate node (of the first device) may consider the first intermediate node (of the first device) not able to perform R2D transmission to the (first) device after receiving the second information of functionalities stopped. For another example, the network may send a second information to a first intermediate node (of a first device) when a second intermediate node (of the first device) functionalities start/stop. The first intermediate node (of the first device) may consider the second intermediate node (of the first device) able to perform D2R transmission from the (first) device after receiving the second information of functionalities started. The first intermediate node (of the first device) may consider the second intermediate node (of the first device) not able to perform D2R transmission from the (first) device after receiving the second information of functionalities stopped.

The (first, second) information may be (or comprise) the set of resources for R2D transmission and/or D2R transmission. The set of resources may be one or more resources in time and frequency domain. The one or more resources may be aperiodic (or one-shot) or periodic (e.g., comprising time/frequency resources in each period with a periodicity). The set of resources may be allocated/scheduled/assigned/provided/indicated via dynamic grant or (type-1 or type-2) configured grant. The one or more resources may be allocated/scheduled/assigned/provided/indicated semi-persistently. The one or more resources may be located in consecutive or separate TTIs (in time domain). The one or more resources may be the same (i.e. occupy the same frequency resources) or different (e.g., allocated/scheduled/assigned/provided/indicated by the NW) in frequency domain. Alternatively or additionally in certain embodiments, the set of resources may be a resource pool comprising multiple resources (in time and frequency domain). The resource pool may comprise a number of consecutive frequency resources in associated multiple TTIs. A starting frequency resource (e.g., PRB, subcarrier, sub-channel, or a unit of frequency resource), an ending frequency resource and/or the number of consecutive frequency resources for the resource pool may be allocated/scheduled/assigned/provided/indicated by the NW. The associated multiple TTIs may be located in consecutive TTIs or separate TTIs. Alternatively or additionally in certain embodiments, the set of resources may be one or multiple frequency (sub-)bands comprising multiple resources (in time and frequency domain). A starting frequency resource, an ending frequency resource, and/or the number of consecutive frequency resources for the resource pool may be allocated/scheduled/assigned/provided/indicated by the NW. The associated multiple TTIs (e.g., indicated by the NW) may be located in consecutive TTIs or separate TTIs.

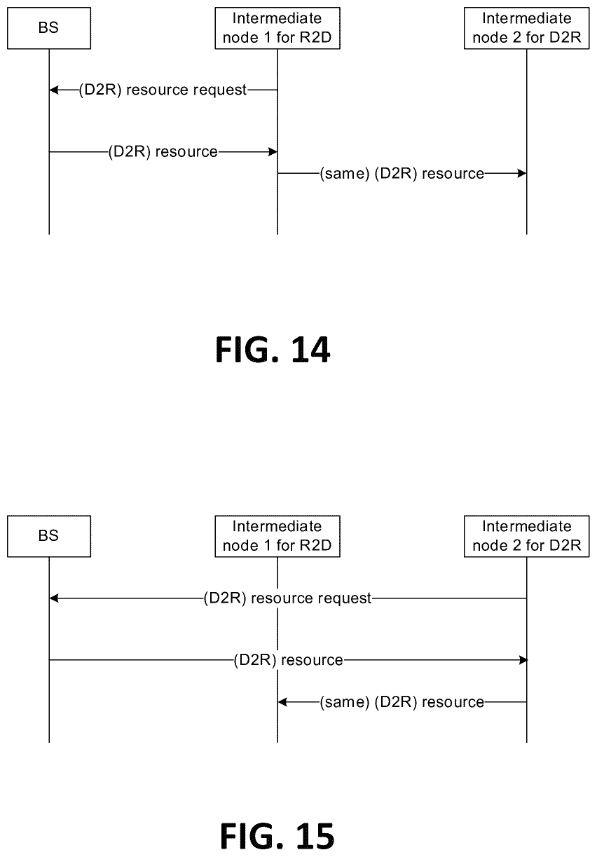

For example, as shown in FIG. 14, a first intermediate node (of a first device) may request for a set of resources (available) for the (first) device to perform a (subsequent) D2R transmission. The first intermediate node (of the first device) may send a signaling to the (first) device to indicate the set of resources (available) for the device to perform the (subsequent) D2R transmission. The first intermediate node (of the first device) may send a first information to a second intermediate node (of the first device) to indicate one or more resources to monitor PDRCH from the (first) device. The second intermediate node (of the first device) may monitor PDRCH within the one or more resources indicated in the first information. The second intermediate node (of the first device) may not monitor PDRCH outside the one or more resources indicated in the first information. For another example, as shown in FIG. 15, a second intermediate node (of a first device) may request for a set of resources (available) for the device to perform the (subsequent) D2R transmission. The second intermediate node (of the first device) may send a first information to a first intermediate node (of the first device) to indicate a one or more resources to the (first) device for the (subsequent) D2R transmission.

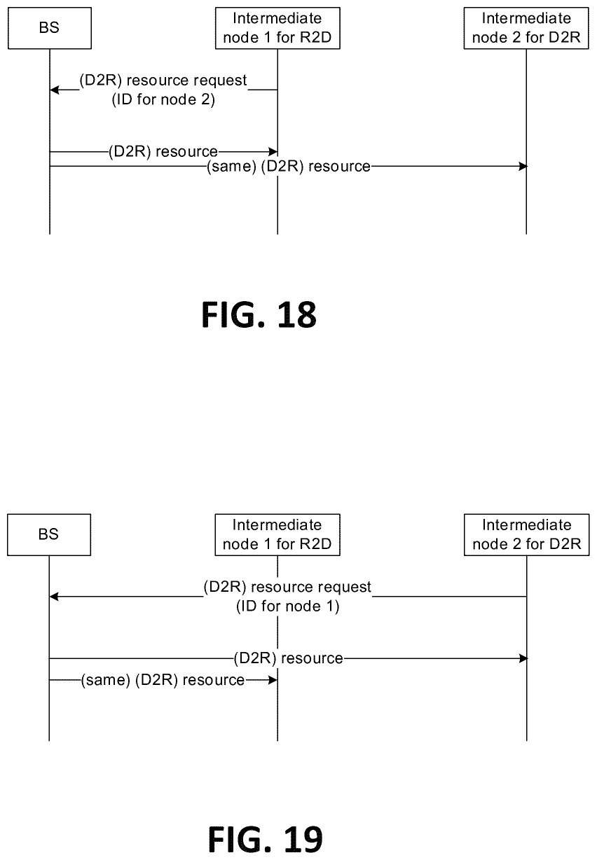

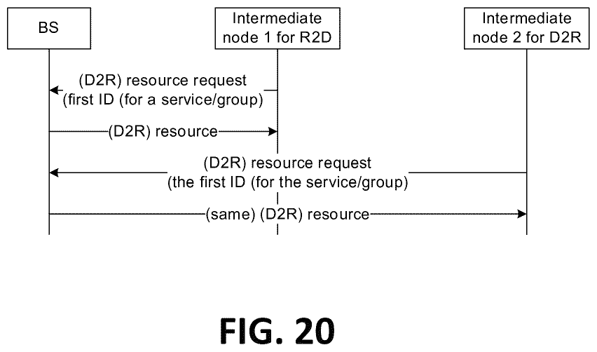

For another example, a second intermediate node (of a first device) may receive a signaling from a (first) device with a preference on a set of resources (available) for the (first) device to perform a (subsequent) R2D reception. The second intermediate node (of the first device) may send a first information to a first intermediate node (of the first device) to indicate the one or more resources to send PRDCH to the (first) device. The first intermediate node (of the first device) may send PRDCH within the one or more resources indicated in the first information. The first intermediate node (of the first device) may not send PRDCH outside the one or more resources indicated in the first information. For example, as shown in FIG. 18, a first intermediate node (of a first device) may request for a set of resources (available) for the (first) device to perform the (subsequent) D2R transmission. The network may send a second information to the first intermediate node and/or a second intermediate node (of the first device) with the configuration/indication of the set of resources (available) for the (first) device to perform the (subsequent) D2R transmission. The first intermediate node (of a first device) may send a signaling to the (first) device to indicate one or more resources (available) for the device to perform the (subsequent) D2R transmission. The second intermediate node (of the first device) may monitor PDRCH within the one or more resources indicated in the second information. The second intermediate node (of the first device) may not monitor PDRCH outside the one or more resources indicated in the second information. For another example, as shown in FIG. 19, a second intermediate node (of a first device) may receive a signaling from a (first) device with a preference/expectance on one or more resources (available) for the (first) device to perform the (subsequent) D2R transmission. The second intermediate node (of the first device) may send a report/request of the (first) device's preference/expectance on the one or more resources to the network. The network may send a second information to a first intermediate node (of the first device) and/or the second intermediate node to indicate the (first device's preferred/expected) one or more resources in the (subsequent) R2D transmission to the (first) device. For another example, a second intermediate node (of a first device) may receive a signaling from a (first) device with a preference/expectance on a one or more resources (available) for the (first) device to perform (subsequent) R2D reception. The second intermediate node (of the first device) may send a report/request of the (first) device's preference/expectance on the one or more resources to the network. The network may send a second information to a first intermediate node (of the first device) and/or the second intermediate node to indicate the (first device's preferred/expected) one or more resources to send PRDCH to the (first) device. The first intermediate node (of the first device) may send PRDCH within the one or more resources indicated in the second information. The first intermediate node (of the first device) may not send PRDCH outside the one or more resources indicated in the second information. For another example, as shown in FIG. 20, a first intermediate node (of a first device) may send a (first) request for a (first) set of resources (available) for the (first) device to perform the (subsequent) D2R transmission (e.g., before the first intermediate node performs D2R transmission). The (first) request may include an (first) ID for (intermediate node) pairing and/or service type (e.g., command, inventory, contention-based access, contention-free access). The network may send a (first) second information to the first intermediate node (of the first device) with the configuration/indication of the (first) set of resources. A second intermediate node (of a first device) may send a (second) request for a (second) set of resources (available) for the (first) device to perform the (subsequent) D2R transmission (e.g., upon receiving a signaling from a (first) device with a preference/expectance on D2R resources). The (second) request may include the (first) ID for (intermediate node) pairing and/or service type. The network may send a (second) second information to the first intermediate node (of the first device) with the configuration/indication of the (second) set of resources. The first set of resources may be the same as the second set of resources. The first set of resources may be different from the second set of resources.

For example, the first information may be/comprise a first set of resources for R2D transmission and a second set of resources for D2R reception. For another example, the network may send a second information to the first intermediate node with the configuration/indication of a first set of resources to perform R2D transmission. The network may send another second information to the second intermediate node with the configuration/indication of a second set of resources to perform D2R reception. The first intermediate node may perform one or more R2D transmissions within the first set of resources (e.g., for one or more ambient IoT devices, which device IDs may or may not be exchanged between the first and the second intermediate nodes beforehand). The first intermediate node may not perform any R2D transmissions outside the first set of resources (e.g., for the one or more ambient IoT devices). The second intermediate node may monitor/detect/receive one or more D2R transmissions within the second set of resources (e.g., for the one or more ambient IoT devices). The second intermediate node may not monitor/detect/receive any D2R transmissions outside the second set of resources (e.g., for the one or more ambient IoT devices). Preferably in certain embodiments, the first set of resources and the second set of resources may be exclusive or non-overlapped. Preferably or alternatively in certain embodiments, the first set of resources and the second set of resources may be (partially) overlapped. Preferably in certain embodiments, the first set of resources and the second set of resources may be TDMed, e.g., the first set of resources and the second set of resources are separated in different timings/occasions/TTIs/slots/symbols, while the first set of resources and the second set of resources may comprise some overlapped frequency resources. Preferably in certain embodiments, the first set of resources and the second set of resources may be FDMed, e.g., the first set of resources and the second set of resources are separated in different PRBs/BWPs/bandwidths/frequency bands/frequency (sub-)bands/spectrums, while the first set of resources and the second set of resources may be overlapped in time domain. Preferably in certain embodiments, the first set of resources and the second set of resources may be TDMed and FDMed.

Preferably in certain embodiments, the set of resources, the first set of resources for R2D transmission, and/or the second set of resources may be indicated/configured/provided by network.

The (first, second) information may be (or comprise) whether the R2D transmission is successful. For example, a (first) device may send a positive acknowledgment in a D2R transmission to a second intermediate node (of the first device), if (at least) the R2D signal sent by a first intermediate node (of the first device) is received/decoded successfully. Alternatively or additionally in certain embodiments, the (first) device may send a negative acknowledgment in a D2R transmission to a second intermediate node (of the first device), if (at least) the R2D signal sent by the first intermediate node (of the first device) is received/decoded unsuccessfully. The second intermediate node (of the first device) may send a first information of whether the R2D transmission is successful to the first intermediate node (of the first device) after receiving the (positive or negative) acknowledgment from the (first) device. Alternatively or additionally in certain embodiments, the network may send a second information of whether the R2D transmission is successful to the first intermediate node (of the first device) after receiving the (positive or negative) acknowledgment from the second intermediate node.

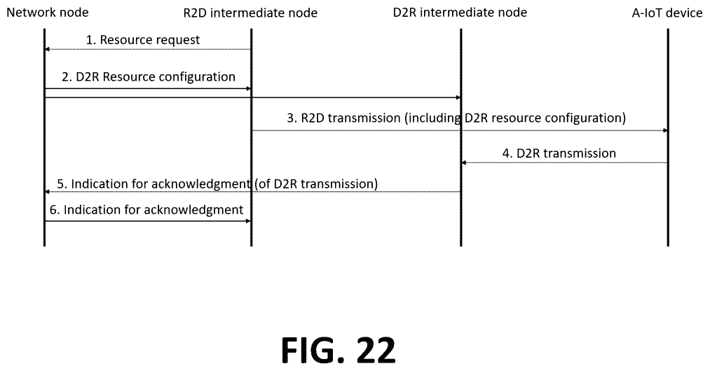

To solve the issue, in response to receiving a first transmission (e.g., related to resource request) from a first intermediate node, a network node may transmit a second information to both the first intermediate node and a second intermediate node. The R2D intermediate node may send a request for A-IoT resources to the network node. Upon receiving the request, the network node may send a first D2R resource configuration/indication to the R2D intermediate node, and/or send a second D2R resource configuration/indication to the D2R intermediate node. (At least) one or more (time/frequency) (radio) resources (for a first D2R transmission) may be determined/derived from the first D2R resource configuration/indication. (At least) the one or more (time/frequency) (radio) resources (for the first D2R transmission) may be determined/derived from the second D2R resource configuration/indication. The first intermediate node may indicate/include the one or more resources (and/or resource configuration of the one or more resources, e.g., the first resource configuration) in a first R2D transmission/signaling to a device. The device may perform the first D2R transmission on the one or more D2R resources. In response to receiving the first D2R transmission, the second intermediate node may transmit an acknowledgment indication (e.g., corresponded to the first D2R transmission) to the network node. In addition, in response to receiving the acknowledgment indication from the D2R intermediate node, the network node may send the acknowledgment indication to the R2D intermediate node. The acknowledgment indication may be whether the first D2R transmission is successfully decoded or not. An example is shown in FIG. 22.

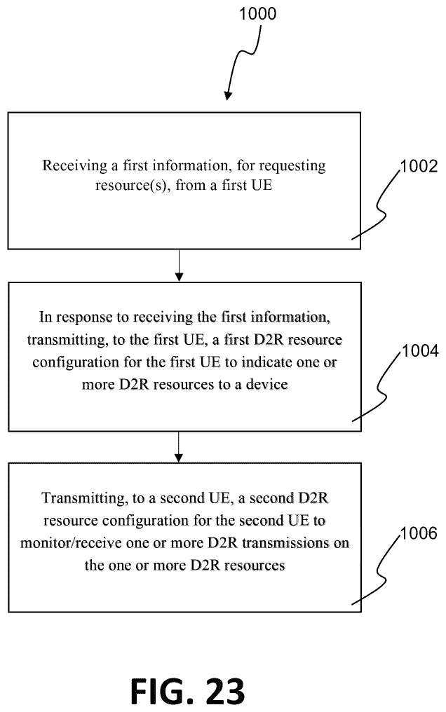

Referring to FIG. 23, with this and other concepts, systems, and methods of the present invention, a method 1000 for a network node in a wireless communication system comprises receiving a first information, for requesting resource(s), from a first UE (step 1002), in response to receiving the first information, transmitting, to the first UE, a first D2R resource configuration for the first UE to indicate one or more D2R resources to a device (step 1004), and transmitting, to a second UE, a second D2R resource configuration for the second UE to monitor/receive one or more D2R transmissions on the one or more D2R resources (step 1006).

Referring back to FIGS. 3 and 4, in one or more embodiments from the perspective of a network node in a wireless communication system, the device 300 includes a program code 312 stored in memory 310 of the transmitter. The CPU 308 could execute program code 312 to: (i) receive a first information, for requesting resource(s), from a first UE; (ii) in response to receiving the first information, transmit, to the first UE, a first

D2R resource configuration for the first UE to indicate one or more D2R resources to a device; and (iii) transmit, to a second UE, a second D2R resource configuration for the second UE to monitor/receive one or more D2R transmissions on the one or more D2R resources. Moreover, the CPU 308 can execute the program code 312 to perform all of the described actions, steps, and methods described above, below, or otherwise herein.

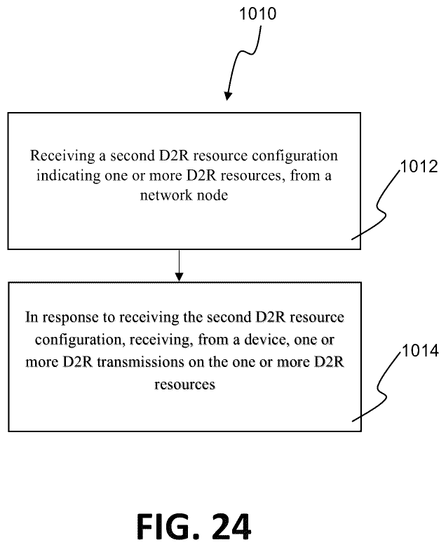

Referring to FIG. 24, with this and other concepts, systems, and methods of the present invention, a method 1010 for a second UE in a wireless communication system comprises receiving a second D2R resource configuration indicating one or more D2R resources, from a network node (step 1012), and in response to receiving the second D2R resource configuration, receiving, from a device, one or more D2R transmissions on the one or more D2R resources (1014).

Referring back to FIGS. 3 and 4, in one or more embodiments from the perspective of a second UE in a wireless communication system, the device 300 includes a program code 312 stored in memory 310 of the transmitter. The CPU 308 could execute program code 312 to: (i) receive a second D2R resource configuration indicating one or more D2R resources, from a network node; and (ii) in response to receiving the second D2R resource configuration, receive, from a device, one or more D2R transmissions on the one or more D2R resources. Moreover, the CPU 308 can execute the program code 312 to perform all of the described actions, steps, and methods described above, below, or otherwise herein.

In various embodiments, the method further comprises receiving a third information from the second UE, wherein the third information includes an indication associated with a first D2R transmission, and/or transmitting a fourth information to the first UE, wherein the fourth information includes the indication associated with the first D2R transmission.

In various embodiments, the first UE performs ambient IoT intermediate node functionality/operation for performing R2D transmissions, and/or the second UE performs ambient IoT intermediate node functionality/operation for performing D2R receptions.

In various embodiments, a third D2R resource configuration is transmitted from the first UE to the device via an R2D transmission.

In various embodiments, the first D2R resource configuration indicates time domain and/or frequency domain of radio resources for at least a first D2R transmission, and/or the second D2R resource configuration indicates time domain and/or frequency domain of the radio resources for at least the first D2R transmission.

In various embodiments, the third D2R resource configuration indicates time domain and/or frequency domain of radio resources for at least the first D2R transmission.

In various embodiments, the indication associated with the first D2R transmission indicates whether the first D2R transmission is successfully decoded/received or not by the second UE.

In various embodiments, the first D2R transmission is performed by the device on the radio resources indicated by the D2R resource configuration.

In various embodiments, the method further comprises receiving an ID of the first UE from the first UE and/or an ID of the second UE from the second UE.

In various embodiments, the first UE and the second UE are UEs capable of ambient IoT intermediate node capabilities, and/or the first UE and the second are (ambient IoT) intermediate nodes.

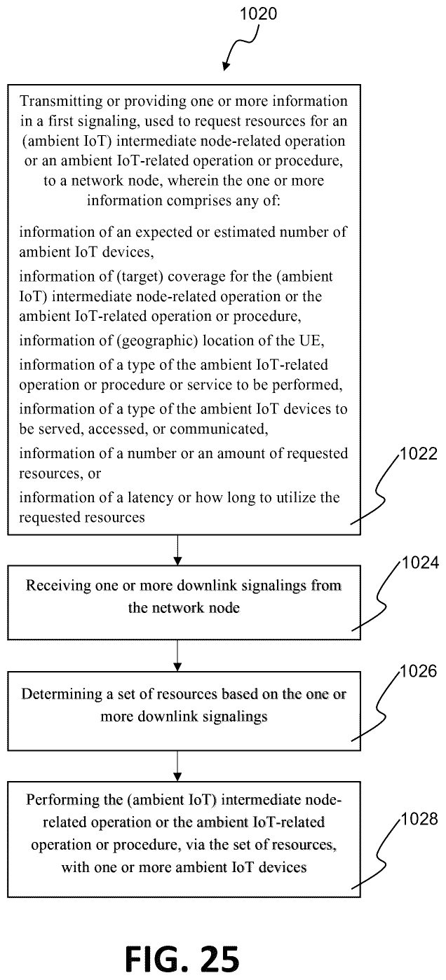

Referring to FIG. 25, with this and other concepts, systems, and methods of the present invention, a method 1020 for a UE capable of (acting or operating as) an ambient IoT intermediate node in a wireless communication system comprises transmitting or providing one or more information in a first signaling, used to request resources for an (ambient IoT) intermediate node-related operation or an ambient IoT-related operation or procedure, to a network node, wherein the one or more information comprises any of: information of an expected or estimated number of ambient IoT devices, information of (target) coverage for the (ambient IoT) intermediate node-related operation or the ambient IoT-related operation or procedure, information of (geographic) location of the UE, information of a type of the ambient IoT-related operation or procedure or service to be performed, information of a type of the ambient IoT devices to be served, accessed, or communicated, information of a number or an amount of requested resources, or information of a latency or how long to utilize the requested resources (step 1022), receiving one or more downlink signalings from the network node (step 1024), determining a set of resources based on the one or more downlink signalings (step 1026), and performing the (ambient IoT) intermediate node-related operation or the ambient IoT-related operation or procedure, via the set of resources, with one or more ambient IoT devices (step 1028).

In various embodiments, the UE transmits or provides a second signaling or indication to indicate need of more resources, e.g., if the UE needs to keep the set of resources or after or when the UE performs the (ambient IoT) intermediate node-related operation or the ambient IoT-related operation or procedure.

In various embodiments, the UE transmits or provides a third signaling or indication to indicate no need of (keeping/utilizing) more resources or to indicate an ACK or release, e.g., if the UE does not need utilization of the set of resources or if the UE finishes the (ambient IoT) intermediate node-related operation or the ambient IoT-related operation or procedure.

In various embodiments, the set of resources are located in consecutive TTIs indicated by the one or more downlink signalings, the set of resources are in one or multiple frequency bands or sub-bands indicated by the one or more downlink signalings, and/or the set of resources are within a resource pool indicated by the one or more downlink signalings.

In various embodiments, the one or more downlink signalings comprise at least a configuration of a resource pool for the ambient IoT-related operation or procedure, the UE utilizes part or all of the set of resources for performing the ambient IoT-related operation or procedure, the one or more downlink signalings comprise a first downlink control information for activating the resource pool, and/or the one or more downlink signalings comprise a second downlink control information for deactivating or releasing the resource pool.

In various embodiments, the information of the expected or estimated number of ambient IoT devices means the information of the expected or estimated number of ambient IoT devices to be accessed for the ambient IoT-related operation/procedure, the information of the expected or estimated number of ambient IoT devices means the information of the expected or estimated number of ambient IoT devices to be inventoried or commanded, and/or the information of the expected or estimated number of ambient IoT devices comprises a quantified or classified number or range of the expected or estimated number of ambient IoT devices.

In various embodiments, the information of the type of the ambient IoT-related operation or procedure or service comprises at least any of a contention-based access procedure, a contention-free access procedure, an inventory procedure or operation, and/or a command procedure or operation.

In various embodiments, the information of the number or amount of requested resources means the information of the number or amount of requested resources for performing the (ambient IoT) intermediate node-related operation or the ambient IoT-related operation or procedure, the information of the number or amount of requested resources comprises at least any of a required number or amount of PRBs, subcarriers, sub-channels, frequency bands or sub-bands, and/or transmission or occupied bandwidths in frequency domain, or the information of the number or amount of requested resources comprises at least a required number or amount of symbols, set of symbols, sub-slots, slots, subframes, milliseconds, and/or TTIs in time domain.

In various embodiments, the information of the latency and/or how long to utilize the requested resources comprises at least a time duration for performing the (ambient IoT) intermediate node-related operation or the ambient IoT-related operation or procedure.

In various embodiments, the method further comprises prohibiting, after or in response to transmission of the one or more information, from transmitting or retransmitting the one or more information for a specific time duration to the network node.

In various embodiments, performing the (ambient IoT) intermediate node-related operation or the ambient IoT-related operation or procedure comprises performing one or more R2D transmissions and/or receiving one or more D2R transmissions, via the set of resources, with the one or more ambient IoT devices.

In various embodiments, the method further comprises receiving a configuration of the (ambient IoT) intermediate node-related operation or the ambient IoT-related operation or procedure, or starting to act or operate as the ambient IoT intermediate node in response to receiving an activation or enabling signaling and/or the configuration from the network node.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) transmit or provide one or more information in a first signaling, used to request resources for an (ambient IoT) intermediate node-related operation or an ambient IoT-related operation or procedure, to a network node, wherein the one or more information comprises any of: information of an expected or estimated number of ambient IoT devices, information of (target) coverage for the (ambient IoT) intermediate node-related operation or the ambient IoT-related operation or procedure, information of (geographic) location of the UE, information of a type of the ambient

IoT-related operation or procedure or service to be performed, information of a type of the ambient IoT devices to be served, accessed, or communicated, information of a number or an amount of requested resources, or information of a latency or how long to utilize the requested resources; (ii) receive one or more downlink signalings from the network node; (iii) determine a set of resources based on the one or more downlink signalings; and (iv) perform the (ambient IoT) intermediate node-related operation or the ambient

IoT-related operation or procedure, via the set of resources, with one or more ambient IoT devices. Moreover, the CPU 308 can execute the program code 312 to perform all of the described actions, steps, and methods described above, below, or otherwise herein.

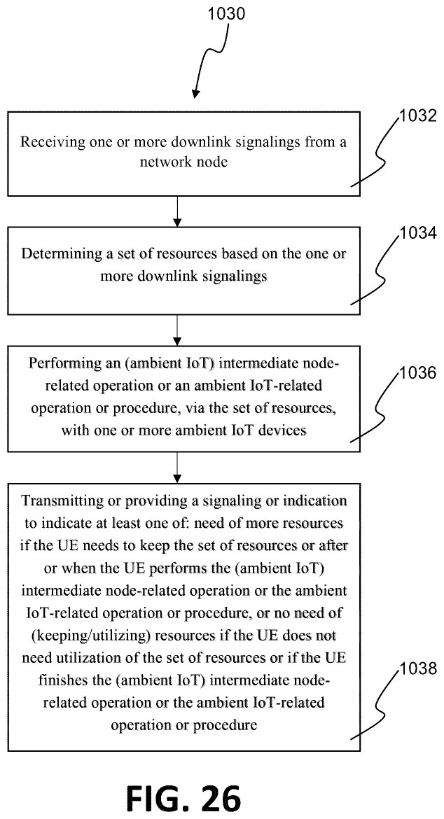

Referring back to FIGS. 3 and 4, in one or more embodiments from the perspective of a network node in a wireless communication system, the device 300 includes a program code 312 stored in memory 310 of the transmitter. The CPU 308 could execute program code 312 to: (i) receive one or more information in a first signaling, used to request resources for an (ambient IoT) intermediate node-related operation or an ambient IoT-related operation or procedure, from a UE, wherein the one or more information comprises any of: information of an expected or estimated number of ambient IoT devices, information of (target) coverage for the (ambient IoT) intermediate node-related operation or the ambient IoT-related operation or procedure, information of (geographic) location of the UE, information of a type of the ambient IoT-related operation or procedure or service to be performed, information of a type of the ambient IoT devices to be served, accessed, or communicated, information of a number or an amount of requested resources, or information of a latency or how long to utilize the requested resources; and (ii) transmit one or more downlink signalings to the UE, indicating one or more sets of resources. Moreover, the CPU 308 can execute the program code 312 to perform all of the described actions, steps, and methods described above, below, or otherwise herein. Referring to FIG. 26, with this and other concepts, systems, and methods of the present invention, a method 1030 for a UE capable of (acting or operating as) an ambient IoT intermediate node in a wireless communication system comprises receiving one or more downlink signalings from a network node (step 1032), determining a set of resources based on the one or more downlink signalings (step 1034), performing an (ambient IoT) intermediate node-related operation or an ambient IoT-related operation or procedure, via the set of resources, with one or more ambient IoT devices (step 1036), and transmitting or providing a signaling or indication to indicate one of: need of more resources if the UE needs to keep the set of resources or after or when the UE performs the (ambient IoT) intermediate node-related operation or the ambient IoT-related operation or procedure, or no need of (keeping/utilizing) resources if the UE does not need utilization of the set of resources or if the UE finishes the (ambient IoT) intermediate node-related operation or the ambient IoT-related operation or procedure (step 1038).

In various embodiments, the method further comprises transmitting or providing one or more information, for requesting resources for the (ambient IoT) intermediate node-related operation or the ambient IoT-related operation or procedure, to the network node, wherein the one or more information comprises any of: information of an expected or estimated number of ambient IoT devices, information of (target) coverage for the (ambient IoT) intermediate node-related operation or the ambient IoT-related operation or procedure, information of (geographic) location of the UE, information of a type of the ambient IoT-related operation or procedure or a service to be performed, information of a type of the ambient IoT devices to be served, accessed, communicated, information of a number or an amount of requested resources, or information of a latency or how long to utilize the requested resources.

In various embodiments, the set of resources are located in consecutive TTIs indicated by the one or more downlink signalings, the set of resources are in one or multiple frequency band or sub-bands indicated by the one or more downlink signalings, and/or the set of resources are within a resource pool indicated by the one or more downlink signalings.

In various embodiments, the one or more downlink signalings comprise at least a configuration of a resource pool for the ambient IoT-related operation or procedure, the UE utilizes part or all of the set of resources for performing the ambient IoT-related operation or procedure, the one or more downlink signalings comprise a first downlink control information for activating the resource pool, and/or the one or more downlink signalings comprise a second downlink control information for deactivating or releasing the resource pool.

In various embodiments, the method further comprises prohibiting, after or in response to transmission of the one or more information, from transmitting or retransmitting the one or more information for a specific time duration to the network node.

In various embodiments, performing the (ambient IoT) intermediate node-related operation or the ambient IoT-related operation or procedure comprises performing one or more R2D transmissions and/or receiving one or more D2R transmissions, via the set of resources, with the one or more ambient IoT devices.

In various embodiments, the method further comprises receiving a configuration of the (ambient IoT) intermediate node-related operation or the ambient IoT-related operation or procedure, or starting to act or operate as the ambient IoT intermediate node in response to receiving an activation or enabling signaling and/or the configuration from the network node.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive one or more downlink signalings from a network node; (ii) determine a set of resources based on the one or more downlink signalings; (iii) perform an (ambient IoT) intermediate node-related operation or an ambient IoT-related operation or procedure, via the set of resources, with one or more ambient IoT devices; and (iv) transmit or provide a signaling or indication to indicate one of: need of more resources if the UE needs to keep the set of resources or after or when the UE performs the (ambient IoT) intermediate node-related operation or the ambient IoT-related operation or procedure, or no need of (keeping/utilizing) resources if the UE does not need utilization of the set of resources or if the UE finishes the (ambient IoT) intermediate node-related operation or the ambient IoT-related operation or procedure. Moreover, the CPU 308 can execute the program code 312 to perform all of the described actions, steps, and methods described above, below, or otherwise herein.

Referring back to FIGS. 3 and 4, in one or more embodiments from the perspective of a network node in a wireless communication system, the device 300 includes a program code 312 stored in memory 310 of the transmitter. The CPU 308 could execute program code 312 to: (i) transmit one or more downlink signalings to a UE, indicating one or more sets of resources and (ii) receive a signaling or indication from the UE to indicate one of: need of more resources if the UE needs to keep the set of resources or after or when the UE performs the (ambient IoT) intermediate node-related operation or the ambient IoT-related operation or procedure, or no need of (keeping/utilizing) resources if the UE does not need utilization of the set of resources or if the UE finishes the (ambient IoT) intermediate node-related operation or the ambient IoT-related operation or procedure. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for a User Equipment (UE) capable of acting or operating as an ambient Internet-of-Things (IoT) intermediate node, comprising:
transmitting or providing one or more information in a first signaling, used to request resources for an intermediate node-related operation or an ambient IoT-related operation or procedure, to a network node, wherein the one or more information comprises any of:
information of an expected or estimated number of ambient IoT devices,
information of coverage for the intermediate node-related operation or the ambient IoT-related operation or procedure,
information of location of the UE,
information of a type of the ambient IoT-related operation or procedure or service to be performed,
information of a type of the ambient IoT devices to be served, accessed, or communicated,
information of a number or an amount of requested resources, or
information of a latency or how long to utilize the requested resources;
receiving one or more downlink signalings from the network node;
determining a set of resources based on the one or more downlink signalings; and
performing the intermediate node-related operation or the ambient IoT-related operation or procedure, via the set of resources, with one or more ambient IoT devices.

2. The method of claim 1, further comprising:
transmitting or providing a second signaling or indication to indicate need of more resources if the UE needs to keep the set of resources or after or when the UE performs the intermediate node-related operation or the ambient IoT-related operation or procedure, and/or
transmitting or providing a third signaling or indication to indicate no need of more resources or to indicate an acknowledgement (ACK) or release if the UE does not need utilization of the set of resources or if the UE finishes the intermediate node-related operation or the ambient IoT-related operation or procedure.

3. The method of claim 1, wherein:
the set of resources are located in consecutive Transmission Time Intervals (TTIs) indicated by the one or more downlink signalings,
the set of resources are in one or multiple frequency bands or sub-bands indicated by the one or more downlink signalings, and/or
the set of resources are within a resource pool indicated by the one or more downlink signalings.

4. The method of claim 1, wherein:
the one or more downlink signalings comprise at least a configuration of a resource pool for the ambient IoT-related operation or procedure,
the UE utilizes part or all of the set of resources for performing the ambient IoT-related operation or procedure,
the one or more downlink signalings comprise a first downlink control information for activating the resource pool, and/or
the one or more downlink signalings comprise a second downlink control information for deactivating or releasing the resource pool.

5. The method of claim 1, wherein:
the information of the expected or estimated number of ambient IoT devices means the information of the expected or estimated number of ambient IoT devices to be accessed for the ambient IoT-related operation/procedure,
the information of the expected or estimated number of ambient IoT devices means the information of the expected or estimated number of ambient IoT devices to be inventoried or commanded, and/or
the information of the expected or estimated number of ambient IoT devices comprises a quantified or classified number or range of the expected or estimated number of ambient IoT devices.

6. The method of claim 1, wherein the information of the type of the ambient IoT-related operation or procedure or service comprises at least any of a contention-based access procedure, a contention-free access procedure, an inventory procedure or operation, and/or a command procedure or operation.

7. The method of claim 1, wherein:
the information of the number or amount of requested resources means the information of the number or amount of requested resources for performing the intermediate node-related operation or the ambient IoT-related operation or procedure,
the information of the number or amount of requested resources comprises at least any of a required number or amount of Physical Resource Blocks (PRBs), subcarriers, sub-channels, frequency bands or sub-bands, and/or transmission or occupied bandwidths in frequency domain, or
the information of the number or amount of requested resources comprises at least a required number or amount of symbols, set of symbols, sub-slots, slots, subframes, milliseconds, and/or TTIs in time domain.

8. The method of claim 1, wherein the information of the latency and/or how long to utilize the requested resources comprises at least a time duration for performing the intermediate node-related operation or the ambient IoT-related operation or procedure.

9. The method of claim 1, further comprising prohibiting, after or in response to transmission of the one or more information, from transmitting or retransmitting the one or more information for a specific time duration to the network node.

10. The method of claim 1, wherein performing the intermediate node-related operation or the ambient IoT-related operation or procedure comprises performing one or more Reader-to-Device (R2D) transmissions and/or receiving one or more Device-to-Reader (D2R) transmissions, via the set of resources, with the one or more ambient IoT devices.

11. The method of claim 1, further comprising:
receiving a configuration of the intermediate node-related operation or the ambient IoT-related operation or procedure, or
starting to act or operate as the ambient IoT intermediate node in response to receiving an activation or enabling signaling and/or the configuration from the network node.

12. A method for a User Equipment (UE) capable of acting or operating as an ambient Internet-of-Things (IoT) intermediate node, comprising:
receiving one or more downlink signalings from a network node;
determining a set of resources based on the one or more downlink signalings;
performing an intermediate node-related operation or an ambient IoT-related operation or procedure, via the set of resources, with one or more ambient IoT devices; and
transmitting or providing a signaling or indication to indicate at least one of:
need of more resources if the UE needs to keep the set of resources or after or when the UE performs the intermediate node-related operation or the ambient IoT-related operation or procedure, or
no need of resources if the UE does not need utilization of the set of resources or if the UE finishes the intermediate node-related operation or the ambient IoT-related operation or procedure.

13. The method of claim 12, further comprising:
transmitting or providing one or more information, for requesting resources for the intermediate node-related operation or the ambient IoT-related operation or procedure, to the network node, wherein the one or more information comprises any of:
information of an expected or estimated number of ambient IoT devices,
information of coverage for the intermediate node-related operation or the ambient IoT-related operation or procedure,
information of location of the UE,
information of a type of the ambient IoT-related operation or procedure or a service to be performed,
information of a type of the ambient IoT devices to be served, accessed, communicated,
information of a number or an amount of requested resources, or
information of a latency or how long to utilize the requested resources.

14. The method of claim 12, wherein:
the set of resources are located in consecutive Transmission Time Intervals (TTIs) indicated by the one or more downlink signalings,
the set of resources are in one or multiple frequency band or sub-bands indicated by the one or more downlink signalings, and/or
the set of resources are within a resource pool indicated by the one or more downlink signalings.

15. The method of claim 12, wherein:
the one or more downlink signalings comprise at least a configuration of a resource pool for the ambient IoT-related operation or procedure,
the UE utilizes part or all of the set of resources for performing the ambient IoT-related operation or procedure,
the one or more downlink signalings comprise a first downlink control information for activating the resource pool, and/or
the one or more downlink signalings comprise a second downlink control information for deactivating or releasing the resource pool.

16. The method of claim 12, further comprising prohibiting, after or in response to transmission of the one or more information, from transmitting or retransmitting the one or more information for a specific time duration to the network node.

17. The method of claim 12, wherein performing the intermediate node-related operation or the ambient IoT-related operation or procedure comprises performing one or more Reader-to-Device (R2D) transmissions and/or receiving one or more Device-to-Reader (D2R) transmissions, via the set of resources, with the one or more ambient IoT devices.

18. The method of claim 12, further comprising:
receiving a configuration of the intermediate node-related operation or the ambient IoT-related operation or procedure, or
starting to act or operate as the ambient IoT intermediate node in response to receiving an activation or enabling signaling and/or the configuration from the network node.
